(19) United States
(12) Patent Application Publication
(10) Pub. No.: US 2006/0266229 A1
(43) Pub. Date: Nov. 30, 2006

(54) Coffee roasting control system and process

(75) Inventor: Paul Ribich, Clearwater, FL (US)

Correspondence Address: DENNIS G. LAPOINTE;LAPOINTE LAW GROUP, PL, PO BOX 1294, TARPON SPRINGS, FL, 34688-1294, US

(73) Assignee: Ambex, Inc., Clearwater, FL (US)

(21) Appl. No.: 11/357,258

(22) Filed: Feb. 17, 2006

Related U.S. Application Data
(60) Provisional application No. 60/683,851, filed on May 24, 2005.

(51) Int. Cl. B02C 25/00

(52) U.S. Cl. 99/486

(57) ABSTRACT

The inventive process comprises micro-processing means utilizing a coffee roaster control algorithm for controlling the roast process of coffee beans. The algorithm utilizes curve fitting techniques to calculate polynomial coefficients used in generating a smooth curve to control the coffee bean temperature during the roast process. Through the use of multiple set points and actual historical data, the polynomial coefficients are generated. The coefficients are then used to plot a graph that indicates the path the roast process will try and maintain.

### RELATED APPLICATION

This application claims the benefit of U.S. provisional patent application Ser. No. 60/683,851 filed May 24, 2005.

### BACKGROUND OF THE INVENTION

Previous coffee roasting control systems lack the ability to control the coffee roasting process by means of a smooth bean temperature curve. Existing systems are capable of changing output and air flow at predetermined points, are capable of analyzing the rise of coffee temperature over a predefined period of time and then maintaining the rise for the remainder of the roast, some systems are capable of recording changes made during the roast and than have the ability to repeat those changes (again output to burner and air flow changes) others are capable of controlling the environment temperature during the roast. One big disadvantage of these systems is the ability to automatically adjust for changes in batch (amount of coffee beans) size, as well as changes in the environment and other ambient variables. By not being able to adjust for these changes, the quality and consistence of the roast process is less than desirable. When roasting coffee the desired result is that batch to batch the final product be consistent. The only way to truly make the final product consistent is to control the media (coffee bean) temperature through out the roast process.

By way of background, it may be useful for a better understanding of the roasting industry and the components used to include the following introductory information.

The first question that comes to mind is: What is control? Control is the manipulation of variables to achieve the desired results. When it comes to coffee roasting, what are the desired results? The goal is to roast the particular green coffee to its ultimate potential; body, flavor, aroma, acidity, etc. Control (manipulation of variables) is how this goal is achieved. The variables manipulated are heat energy, air flow, time, coffee load. By manipulating these variables, the end result of the coffee roast is controlled. Different green coffees require different manipulation of the variables. All coffee roasters have in-line controls of one type or another; manual, semi-automatic or fully automatic.

Terminology—the following includes some of the basic terminology often discussed and will enable a reader to better understand the inventive roasting process and the interrelatedness of the components.

Control—Control is the term used when talking about how the roaster is operated. Here is a brief description of the different categories. Manual control refers to controlling the roaster without the help of any digital hardware; the operator must manually adjust all aspects of the roaster equipment; gas flow/pressure, air flow, opening and closing of the load doors, etc.

Semi-automatic control utilizes the assistance of a digital controller that will control the burner flame by manipulating a gas valve, which in return manipulates the burner flame. This method will require the use of one or more temperature probes. Most other aspects of the roaster equipment are still manually controlled by the operator.

Automatic control will utilize, in most cases, a PLC (Programmable Logic Controller) or a PC (Personal Computer) to not only control the burner flame and roasting chamber temperature, but will also control other aspects of the roasting equipment; load doors, air flow, data logging and visual indicators just to name a few.

BTU's—British Thermal Units, are the most common measure of heat output used in the industry. BTU's are the unit of measure for defining the amount of heat energy required to raise one pound of water from 32° F. to 33° F. at standard atmospheric pressure.

Air Flow—When air flow is being discussed, it is usually in terms of the air moving through the roasting chamber. Air flow is measured in CFM (Cubic Feet per Minute). Air flow is the means of removing the exhaust gas, removing the chaff and replenishing the oxygen for the burners. Inadequate air flow leads to numerous problems when roasting. The Air flow through the roasting drum is also a means of controlling the roast profile, more or less air flow will either decrease or increase convective heat. If the air flow is reduced, the convective heating of the coffee beans is reduced in the roasting chamber; if it is increased, more of the heat transfer is convective, like an air roaster. An air roaster's main principal of operation is based on large volumes of air flow to keep the beans suspended, where a drum roaster depends more on conductive, radiant and convective heat transfer.

Controller—A controller is a device that is used to take in a signal, usually from a temperature probe, and output a signal to control the heat source, gas valve or electrical current. A controller can be as simple as a device that maintains a single set point, or as complicated as one that continuously calculates set points for a roast profile.

These units can be as simple as a bimetallic switch to a dedicated computer system. Currently the most common type of controller in the industry is a stand alone controller that uses a temperature probe input to control the output of the heat source. These are either single set point units or ramping units. PLC's have been the predominant next step in controlling the roaster equipment. They allow for control over other parts of the process, such as load doors and air flow damper valves. Currently there is momentum building in the automation industry towards PC's. PC's are proving to be far more stable then in the past, with added advantages over PLC's.

Probe—A probe is a device used to physically verify a condition or state. There are numerous types of probes that have and are being used; temperature probes (bi-metal, thermocouple, Resistance Temperature Device or RTD), air flow, gas flow or pressure, rotary encoders, flame presence, etc. All of which provide feed back to either the operator or a control unit about the current state of the roasting process. Temperature probes are used to provide constant feed back as to what the temperature is of the environment, beans or exhaust. The operator/controller uses this information to adjust the heat source, if the temperature is too high, the heat source is reduced, if it is too low the heat source is increased. Gas pressure/flow probes are used to indicate the amount of gas being supplied to the burners when a valve is adjusted.

Most other probes used on roasting equipment are for indicating the state of a particular physical condition, and not for actually controlling it, flame presence, rotary encoders, etc.

Valve—A valve is a mechanical device used to control the flow of a media, gas or air, in a roasters case. There are two cases of general concern, control and safety.

Control Valve—A control valve is used to control the flow or pressure of the media, either increase or decrease. The control valve is adjusted by input from the operator or the controller device. The operator will manually adjust the valve either physically, or by adjusting a piece of hardware that will adjust an input signal to the valve. A controller device will adjust the output signal it sends to the valve. Both cases are a result of some feedback that the operator or device received.

Safety Valve—A safety valve is an On/Off type of control. If all conditions are within the specified range the valve is: on or open. If the condition is outside the specified range the valve is: off or closed. An example of this is a High Temperature limit switch. As long as the temperature is below the set temperature point, the switch is closed, allowing the heat source to supply energy. If the temperature increases above the set point, the switch will open, in turn cutting off the energy from the heat source. The type of safety valves used should require a manual reset once they have been tripped, in other words, requiring the operator to have to push a button or reset a circuit breaker. Valves that automatically reset themselves are NOT desired for this type of operation. Usually when they trip there is a problem that needs to be addressed, if they automatically reset, they can cause a serious accident to occur, damage to the equipment or worse yet to personnel.

Gauges—Gauges are used to indicate the physical condition of a process, gas or air. Gauges are not used to control the condition, simply to provide feedback to the operator or controller device for adjusting the condition.

Pressure—Pressure gauges are used to indicate the amount of pressure in the system, usually gas pressure. The units of measure are: Column Inches of Water (WIC) or PSI (Pounds per Square Inch), depending on whether you are using propane or natural gas. The pressure in the gas line has a direct correlation to the amount of flow. Since the burners have very small orifices allowing the gas to escape, an increase in pressure will force more gas out through the orifice, while a decrease in pressure will force less gas out. The amount of gas present at the burner will determine the amount of energy available to burn, thus increasing or decreasing the amount of heat supplied to the roasting environment.

Flow—Flow gauges are used to indicate the amount of flow present in the media; gas or air, most likely air. The most common units of measure are CFM (Cubic Feet per Minute). Air flow impacts both the roasting process and the cooling process. Reduced air flow in the roasting process effects the way the heat energy is transferred to the coffee, the efficiency of the burners, and the ability to control the roast process. In general the concern is with too little of air flow. If the flow is reduced, the burners do not have enough oxygen to burn the gas fully, heat transfer becomes more radiant and conductive, and the environment retains more of the heat energy reducing the controllability.

Temperature Probes—This section will discuss various types of temperature probes: design, type, placement and performance. Temperature probes have become an integral part of the roasting process. They give the operator/controller definitive feedback on the state of the process. Prior to the use of temperature probes, the operator was left to interpret the state of the process, which allowed for human error and incompatibility between roasters. Without temperature probes, in-line controllers would not be possible, or at least not as sophisticated. Since there would be no feedback from the process, the controller would only be able to perform a predetermined set of instructions. This would be considered an open loop design. An example of this type of control would be one that is programmed to open or close the control valve by a specific amount at specific times. This could lead to an undesirable outcome: too much heat, not enough heat, too long of roast times, too short of roast times, under roasted coffee or over roasted coffee.

Mechanical Probes—Mechanical temperature probes utilize a physical phenomenon that causes a visual indicator to show temperature. Examples of mechanical temperature probes consist of a mercury or fluid style device that has a tube with gradients and a fluid that expands a constant volume per degree of temperature. The tube is then marked with gradients to indicate the temperature. Another type of mechanical device uses a bimetallic element that expands at a designed rate. The device consists of an element made up from two different metals. The two metals expand at different rates, causing a designed deflection to occur. The device has an indicator attached to the element, and a visible scale that uses the deflection to visually show temperature.

These types of temperature devices can be utilized when the roast process is controlled manually. The only feed back required is for the operator to know the temperature. These types of devices in general, can not be calibrated, and are slow in response.

Digital Probes—Digital probes come in various types and styles. They produce a signal, millivolt or resistance, which an electronic device can read, interpret and display. These types of probes are required when using any kind of in-line controller. They can also be used with a digital display for manual control. The two main types of temperature probes used are: Thermocouples and RTD's.

Both of these probes can be calibrated and are relatively quick in response to temperature change.

Thermocouple—How They Work (Probe and In a System):

Thermocouples are made with elements of dissimilar metals/alloys. The alloys are joined at the sensing end. When both ends of the dissimilar metals are held at different temperatures a current is produced, also referred to as an EMF (electromotive force). This is known as the Seebeck effect. The elements that are joined also have a resistance associated with them, known as a loop resistance. This loop resistance and current flow generate a millivolt signal, which is used with a controller or digital display to interpret and display the temperature. The millivolt signals produced with thermocouples are non-linear. Controllers and digital displays have either look-up tables or mathematical algorithms that interpret the signal before displaying the reading.

Although Thermocouples can be calibrated, they require the use of a special certified probe to use as a reference point. This reference point is used to determine the amount of error in the thermocouple output signal. Once this error is known, it can be used to correct the reading of the signal. This error only takes into account one of the possible error causes. The other possible error cause is at the point where the thermocouple is connected to the sensing device.

When a thermocouple is connected to the sensing device, there is a second dissimilar metal joint made. Thermocouples utilize what is known as cold junction compensation to determine what the temperature is at the connection of the thermocouple to the sensing device. This is usually done with a thermistor or RTD. This is then used in the logic of the device to compensate for the second joint. There is error associated with this compensation that can not be accounted for when entering a correction factor. Although thermocouple systems, a thermocouple and sensing device, can be field calibrated like an RTD system, this will not help at the higher temperatures used in roasting.

Calibration Type of Thermocouples:

There are many different calibration types of thermocouples. Each calibration type produced has a preferred temperature range they work best in. The range that is suggested for each calibration type is the range that the probe produces the most linear output through.

The two calibration types of probes that best fit the range of temperatures roasters work in are J and K. The main difference between the two, other than the dissimilar metals, is that a type J has more resolution per degree of temperature change. In other words there is a greater difference in the millivolt signal per change in temperature.

Thermocouples also have different limits of error, standard or special. In general, standard limits of error are ±3.96° F. (2.2° C.) or 0.4% at 392° F. (200° C.)*, which ever is higher. Special limits of error are ±1.98° F. (1.1° C.) or 0.4% at 392° F. (200° C.)*, again which ever are higher. In addition, when you replace a broken thermocouple, you stand the chance of your readings being as much as 7.92° F. off. This is possible by replacing a probe that was −3.96° F. with a probe that is +3.96° F., if it is a standard limits probe, or 3.96° F. total difference for special limit probes.

* Values are taken from Watlow Electric, Inc. sensor catalog.

RTD (Resistance Temperature Device)—How They Work (Probe and In a System):

RTD's are devices that utilize the change in resistance of the device. The more common design styles utilize a very fine platinum wire that is either wound or attached to a substrate. This element is then attached to lead wire and placed in a protective sheath, or tube. The number of wires that the lead wire has can vary between 2, 3, or 4 wires. The number of wires used depends on the hardware and the required accuracy, 4 wires being the most accurate, and three wires being the most common. The hardware utilizes the additional wire(s) to calculate the resistance in the lead wire, and subtract it from the resistance value used in determining the temperature that the element senses.

As the temperature the RTD is measuring changes, the resistance of the wire changes. Hardware that is used with RTD's supply a very small current through the wire to measure the resistance.

RTD's can be field calibrated by using an ice bath that is at the triple point of water. The triple point of water is when you have ice, liquid and vapor. The mixture is at 32° F. (0° C.). By mixing up an ice bath that is similar in consistency to a slushy, you have reached the triple point of water. The water used for both the liquid and ice portion of the bath should utilize de-ionized water. If de-ionized water is not available, bottled water can be used instead. Once you have the ice bath ready, insert the RTD probe into the ice bath a minimum of 1 to 2 inches. Most RTD elements are 1 inch or shorter, and you want to make sure you have the whole element submerged in the ice bath. Allow the probe to stabilize in the ice bath, at least 10-15 minutes. Once the probe has stabilized, you can determine the offset by calculating the difference between the value displayed and 32.0° F. (0° C.). Use this difference in the controllers' offset value. You have now calibrated the entire temperature system. Since RTD's are very linear in nature, the offset value will be accurate for the entire temperature range that a coffee roasting machine operates in. Both RTD's and Thermocouples have a characteristic called drift. Drift occurs over time where the probe will shift in the out put produced at the same temperature. Repeating the calibration procedure every couple of months will eliminate this phenomenon.

There are two different classes of RTD's, Class A and Class B. The difference between the two classes is their tolerance values and price. Following the calibration description above, either class of element will work fine. Class A elements have ±0.55° F. (0.20° C.) at 392° F. (200° C.)*, Class B elements have ±1.3° F. (0.48° C.) at 392° F. (200° C.)*

* Values are taken from Watlow Electric, Inc. sensor catalog.

Calibration Type (DIN,JIS)—Most RTD's used in the states use DIN standard curve type sensors. DIN stands for Dutch International standard, and JIS is Japanese International Standard. The main difference between the two is the change in resistance each produces per change in temperature. There are also different base ohms that RTD's come in; 10, 100, 1000 ohm, 100 ohm being the most common.

Thermistors—Thermistors work similar to RTD's but in reverse, their resistance decreases with the increase in temperature, were RTD's resistance increases with the increase in temperature. Thermistors are a non-linear resistance device, generally used for limited range low cost applications.

Smart Sensors—Smart sensors are just starting to hit the markets. Smart sensors utilize information on how to correct for the errors in the sensor, type of calibration, when manufactured, and many other pieces of information. They require special hardware that can accept the information, and knows how to process it. So these will not work with legacy (older) controllers, but if your controller ever needs to be replaced, these might be something to consider.

Placement—When it comes to measuring temperature, there is nothing more important than the position of the sensor. The sensor must be in the media that you want to measure. If you want to measure the environment, the probe needs to be in the environment. If you want to measure the bean temperature, the external bean temperature, the probe needs to be in the beans. Having the probe come in contact with the beans on a hit or miss scenario is not good enough, it needs to be immersed in the highest concentration of the beans.

It is important to remember how a temperature sensor works. The sensor is an area type device, meaning that it measures the temperature over an area. The area the probe is measuring is actually the metal tubing that protects it. If the metal tubing is exposed to various temperatures, then the probe will average these temperatures together. The area of the probe that is the most important is the first 10 diameters in length, this is the minimum distance. If the probe diameter being used is 0.125 of an inch in diameter, then 1.25 inches should be immersed in the media. If the bean temperature is being measured, then you need to make sure that the 10 diameter length is in the beans, otherwise you will not have a good reading. This becomes very evident when roasting different load sizes.

If different load sizes are never run, then a good location should be found to place the probe. If you can not get the minimum length of the sensor into the desired location, bend the probe. Find a round object that is at least twice the diameter of the probe diameter, and use this to bend the probe around. If you are using an RTD, keep a close eye on the tube as you bend it, it will have a tendency to kink. Bend slowly and carefully. If you kink the tube you could break the wires that are inside, or cause them to short to the tube. Either case, you will have ruined the probe. Start the bend at the minimum distance, so you ensure the correct length. By bending the probe you have created a lever that the beans will push on, so you will need to anchor the probe in position. You can use either a metal or ceramic compression sleeve, or you can make another bend in the tubing that can be used to secure the probe in place. If you run different size loads make sure the probe is immersed in the media for the minimum length when running the smallest load. You will most likely need to place the probe near the bottom of the drum, making sure to avoid hitting any fins protruding up.

Accuracy vs. Repeatability—There is a Big Difference Between Accuracy and Repeatability.

Accuracy is the exact measure of temperature, and repeatability is the measure of temperature consistently. When it comes to roasting, the most important characteristic is repeatability. Repeatability is what gives constant roasts between batches, even when the batches are different sizes.

Depending on the range of batch sizes to be roasted, and the position of the probe, an operator may not be getting repeatable readings between batches. If the probe is positioned as described above, the operator should minimize the difference in readings between batch sizes. This may cause the reading to be slightly different than the probes previous position, but will provide better repeatability.

Probes that allow an operator to calibrate the sensor system will provide the best accuracy and repeatability when the probe fails and needs to be replaced. As described above, if thermocouples are used, it may be positioned to give the best repeatability, but due to the possible swing in tolerances between probes, it may throw all the profiles off. Let's use the extreme tolerances from above to demonstrate what could happen. If the current sensor you have installed is on the low end of the tolerance −3.96° F., and it is replaced with one that is on the high side of the tolerance +3.96° F., the previous reading of 440° F. is now 440-7.92=432.08. So even though you positioned the probe to be repeatable, you now have to change all the profile values to accommodate the new readings, if you know what the difference is between the two probes. If you use RTD's that are calibrated per above and positioned per above, you will just need to recalibrate the new probe and reposition it in the same location to achieve the desired repeatability.

Ideally you want to achieve both accuracy and repeatability, repeatability being the more important.

Valves—Valves are used to control and manipulate the flow of gas from the supply to the burners. Most roasters consist of two valves, one for manipulating the flow of gas to the burners (Control valve) and one to either allow or deny the flow of gas (Safety valve). Control valves can be either manually adjustable or electronically adjustable. Safety valves are electronically controlled to open when a signal is provided and close automatically if the signal is lost. The following gives some descriptions about the different types of valves available.

Ball Valve—A ball valve consists of a highly polished ball with a hole through it that is the same diameter as the valve body internal dimension. The ball is seated in the valve body to provide a leak tight seal. When the ball is rotated 90 degrees, the valve is either fully open or full closed. The flow is controlled by rotating the ball to a position between 0 and 90 degrees. These are the most common and basic of gas control valves.

Needle Valve—Needle valves provide a higher degree of control over the flow of the gas than ball valves do. Needle valves consist of a needle seated into a tapered hole. The needle screws in and out of the hole, changing the cross-sectional area that the gas can flow through. It usually takes many full turns of the valve to go from fully opened to fully closed. Because it takes many turns, the operator has greater control over the flow of gas to the burners.

Butterfly Valves—A butterfly valve consists of a plate located in the center of the valve body that is attached to a pivot rod. The pivot rod protrudes through the valve body where the operator can manipulate its position. If the plate is rotated perpendicular to the valve body ID, the flow of gas is stopped. When the plate is parallel to the valve body, the flow of gas is at maximum.

Electronic Butterfly Valve—An electronic butter fly valve consists of a butter fly valve with a servo motor that connects to the pivot arm with a couple of levers and a connecting rod. The connecting rod is adjusted on the levers to allow for the valve to be fully opened or closed with the rotation of the servo motor. These valves require the use of a signal conditioner to control them.

Solenoid Valve—A solenoid valve is a simple open/closed valve. There is a coil assembly on the top of the valve that when supplied with an electrical current causes the valve to open. When the current is removed the valve closes. This type of valve will require that the controller be set to a minimum cycle time of 5 seconds, anything faster than this will wear out the valve prematurely. These are mechanical valves that wear out after a given number of cycles. What the controller will do is convert the output percentage to a time open duration, then close the valve for the remainder of the cycle time. These valves are controlled with a relay, either mechanical or solid state.

Modulating Valves—Modulating valves are similar to solenoid valves with the difference of having high and low gas flow settings. Where solenoid valves are either fully open or fully closed, modulating valves switch between the high and low settings. There are two ways these valves can work; the valve can cycle for a period on high and then to low similar to a solenoid valve, or they can cycle quickly between the two settings creating a gas flow that is equivalent to adjusting the flow to a value in between the two settings. This second method is a means to create an adjustable gas flow. If the valve is on the high setting 50% of the time, you will get a gas flow that is equivalent to a setting that is in the middle of the high and low setting. If the valve is on the high setting 75% of the time, then the gas flow is equivalent to setting that is ¾ of the high setting.

Proportional Valves—Proportional valves are solenoid valves that are capable of being electronically adjusted to any point between completely open to almost closed. What I mean by almost closed is that these valves are fully closed, but they have a bypass that allows a minimal amount of gas to bleed through a very small hole to aid in the control of valve positioning. Although these valves have a minimal gas flow when closed, it is not enough to add any heat energy to the roasting process. These valves require a signal conditioner to control the valve position.

There are various types of relays that may be used to control a valve depending on the type of coil used in the valve. Coils can come in various configurations: AC or DC. Depending on the type of controller you are using and the type of electrical current required to activate the valve you may need an external relay, either solid state or mechanical. Controllers can usually handle either AC or DC current. They are equipped with either mechanical or solid state relays. If the valve requires a high current to operate it is best to use external relays that require a small signal current to operate. Mechanical relays are a positive open/closed contact, solid state relays are digital relays. Solid state relays are usually used for the control, while mechanical relays actually open and close the circuit. Solid state relays have a tendency to allow small amounts of current to leak through the digital switch that may cause the valve to open unexpectedly.

Signal conditioners are devices that take a control signal and convert it into an output that the valve requires to operate. Most signal conditioners utilize either 0-10 volt or 4-20 mA signals that are then converted into a corresponding output value. Another type of signal conditioner that could be required is a PWM (Pulse Width Modulation). These types of signal conditioners take a signal input and convert it to a ON/OFF pulse. For example if a 50% signal is sent the PWM will pulse ON for 50% of the cycle time, and off for the other 50%. If the signal is 25%, the PWM pulses ON for 25% of the cycle time and OFF for 75% of the cycle time.

Safety Valves—Safety valves are used to quickly shut off the gas in an emergency. They are usually used with high limit switches that have a separate temperature sensor then the ones used to control the roast process. The switches are set to a value just above the highest temperature value that will ever be reached when roasting. If the temperature ever goes above the set value, the switch will open immediately shutting off the gas flow. These valves also use a sensor that detects a pilot flame, if the pilot flame is not detected the valve will shut off gas flow. These types of valves are design to allow the gas to flow if all the conditions are safe and stop the gas flow at the first detection of a problem.

If the roaster does not have a safety valve and high limit control, they should be added to increase the safety of your equipment, building and personnel. Their cost is inexpensive compared to the possible consequences.

Proportional Integral Derivative (PID) logic control—PID logic control is used in the higher end models of off the shelf controllers and custom control systems. “P” stands for Proportional, “I” stands for Integral, and “D” stands for Derivative. Roasters do not always require that all three components be used, some require PID, some PI, and others just P. After the following explanations this may become more obvious.

When controllers state that they are a PID controller, what they are saying is that there is a mathematical calculation that looks at the set point temperature and the actual temperature, and then runs through some complicated math to derive an output value to try and keep the actual temperature the same as the set point temperature. If the values in the PID array are wrong, the system will either be constantly trying to catch up, or will be oscillating above and below the set point. In other words overshooting and undershooting.

The following descriptions/explanations are based on a constant set point value, say 350° F. The ramping type profiles that roasting uses will require slightly different PID values to keep on track. In most cases you will need a slightly more aggressive P value, and I value, while the D value will be set to zero.

P-Proportional: this is the part of the logic that determines how aggressive the system will be while getting to the set point. For example, if you set the P value to 1, as the system starts getting closer to the set point, it will keep reducing the output to gradually edge up to the set point. If you set the P value to 50, the output would be very aggressive. The output will remain 100% until it is very close to the set point, which will cause it to overshoot. The output will then reduce to 0% until it falls below the set point again, at which time it will calculate back to a high output value and keep repeating this cycle. The cycles will gradually reduce in magnitude, and finally settle into a constant value that is below the set point value. So you want to set the P value to one that is aggressive, yet not too aggressive. In most cases the value should be between 10 and 45. Again a lot has to do with the environment, the equipment and the exhaust. Ideally you want to get the P values set so the temperature follows just below the set point without over shooting, as quickly as possible. Once the P value is determined, it will be time to start adjusting the “I” value.

I-Integral: this value is used to increase the output slightly, gain, which in return raises the actual temperature up to the set point value. The “I” value works just the opposite of the P value. The larger the “I” value the smaller the gain, the smaller the value the larger the gain. In most cases you should be able to adjust the P and I settings to achieve a near perfect temperature following of the curve.

D-Derivative: this is the value that is used in the calculation to smooth out the oscillations about the set point. Because the roasting process is slow in response, there is little need to use the D value. In most cases, the oscillation you will see while roasting is due to incorrect P and I values.

Examples of What P and I Values Do or Output:

Lets first look at P settings:

| | | Temp | |
|---|---|---|---|
| | | difference when | |
| | | output starts to | |
| | | be less than | |
| P value | I value | 100% | |
| 1 | 0 | 99 | degrees |
| 10 | 0 | 10 | degrees |
| 20 | 0 | 5 | degrees |
| 30 | 0 | 3.4 | degrees |

What does this mean? If you look at the temperature difference value say for a P of 20, the difference is 5, which means that the output calculated will be 100% if the temperature difference is 5, 50% when the difference is 2.5 and 0% when the difference is 0. So over the 5 degrees difference the output will be scaled anywhere in between.

Now Hold P Constant and Add Different I Values:

| | | Output % at 2.5 |
|---|---|---|
| | | degrees |
| P value | I value | difference |
| 20 | 0 | 50% |
| 20 | 20 | 50.09% |
| 20 | 10 | 50.18% |
| 20 | .5 | 53.60% |

This shows what kind of gain the “I” value provides. The output calculated is not as simple as shown here. The complete calculation is based on: elapsed time between calculations, how the temperature is responding to the output, how fast the temperature was rising/falling, etc. PID calculations are not easily understood. But hopefully this will provide you with better insight as to what the settings actually do.

Some off the shelf controllers have an auto-tuning option. The auto-tuning can be used to allow the controller to determine what the optimal PID values are for the system. Auto-tuning takes awhile to calculate the values, and must use a set temperature value. Auto-tuning does not work very well for roasting equipment. For one the roasting process is constantly rising in temperature, two you will waste many loads of coffee trying to get it right. The only way it could work is if you know what the relationship between an empty drum and full drum is, so you can Auto tune the roaster empty then make adjustments to account for the load. If you try and Auto tune the roaster with a load in it, you will have to select a temperature to tune about, which will not capture the dynamics of the roaster running a real roast.

Manual Controls—Manual control refers to the equipment being completely controlled by the operator. From reading the state of the coffee to adjusting the burners and determining when the coffee is ready to be released from the drum and when the drum is ready for a new batch to be loaded into the drum. Roasters have been controlled manually since the very beginning. The operators used all their senses to guide and control the roast to produce the desired results. They used sight, smell and sound in determining what adjustments needed to take place.

Hardware—Hardware used in the manual control of roasters is usually kept simple. In most configurations there will be a main valve and an adjustable valve, in some cases this may be the same valve. There may or may not be environment and bean probes. Probes are kind of dependent on the age of the roaster, and whether it has ever been rebuild or modified. There may also be air flow dampers.

Valves—The valve(s) you have are how you will control the burners. If you have separate valves, one for gas flow and one for control, you will need to establish the criteria to allow the main valve to open. In most systems this will require establishing a pilot flame. Once the pilot flame is lit and established, there is a sensor, called a thermopile or thermo-generator that will send a signal back to the main valve indicating that the pilot has been established. The main valve will then open allowing the full amount of gas to flow. If the pilot flame goes out, the main valve will shut off, stopping the flow of gas. Once the gas as begun to flow from the main valve, the operator will use a second valve, ball valve, needle valve or butter fly valve to control the amount of heat the burner puts out. If there is only one valve that acts as both the main valve and the control valve, there will be a lever or dial of some sort that will allow the gas flow to be adjusted. In some cases the control of the burner may simply be either on or off, making control of the roast difficult.

Probes—There could be one, two or no probes at all. If there are any probes, it will depend on what the probe(s) are measuring, as to how they can be used in the control of the roast. If you have no probes at all, everything will depend on sight, smell and sound.

If there is an environment probe, you will use this to control the environment, to coax the coffee into hitting the desired roast time and temperature. You will find with this type of probe, you will need to keep the environment climbing at a constant rate to keep the coffee climbing to its final temperature. The rate could change at various points along the roast to either slow down or speed up the roast. If you roast different size loads, the rates and temperatures you use will need to be adjusted to account for the different loads.

If there is a bean probe, you will use this to directly control the roast. Instead of controlling an environment to coax the coffee, you will control the coffee directly. With bean probes, you have better information to make better adjustment decisions.

Operation—Let's cover a few of the styles that are used with manual control. Again these are just a few examples of how to manually control a roaster to produce the roast you want.

Style 1—The first style of roasting utilizes running the roaster burners at full output to a certain temperature, say 390-400° F., then turning the burner off, allowing the coffee to rise in temperature until the rate of rise starts to slow. Once the rate slows sufficiently, the burner is turned back on until the coffee reaches the final temperature, or a predetermined temperature, then the coffee is allowed to rise on its own until it reaches the final temperature.

Style 2—The next style uses a second control valve that allows the operator to adjust the burner output, and a bean probe. The coffee is loaded into the drum after reaching preheat temperature, then once the bean probe and coffee reach equilibrium temperature, the indicated probe temperature stops decreasing and starts increasing, the operator decreases the burner output, to control the rate of rise through the whole roast. Decreasing the burner output, allows the operator to control the time it takes to reach the final roast temperature. At any time during the roast, the operator has the option to further decrease the burner output or to increase it. Some operators feel some coffee's roast better with soft heat upfront and hard heat at the end. Others like soft heat up front and decrease the heat at the end to account for the exothermic heat the coffee puts off, to extend the roast time. Another method is to provide high heat in the beginning and low heat at the end. Not all coffees will use the same style of roast.

If you are using a manual method of roasting you could still utilize technology to help in the roasting process through the means of a real time data logging system. Using a data logging system does not interfere with the control of the equipment; it simply provides a means to display what is happening when changes are made. This provides instant feed back on how the change affects the roast process. In most cases you may not see the effects instantly, but it may take a few seconds or minutes to truly understand what effect the change had. Real time data logging systems also provide guidance on how to make changes to reach the results you are looking for. For example: Your coffee has reached equilibrium temperature with the temperature probe and you watch the temperature rise. You may notice that it is rising too fast or slow, which allows you to make the right adjustment to either increase the rise or decrease it. The operator is able to make better educated changes in the process this way.

Semi-Automatic Controls—Semi-automatic control as defined herein, is the use of a digital controller that will control the burner per a predefined set point, series of set points, or a profile. The type of controller used will dictate the degree of control over the burners and the type of “profiling” you can perform. Three different types of controllers are discussed, two are off the shelf, and the third is a custom controller. In this industry, the custom controllers are usually one of two types, either a PLC (Programmable Logic Controller) or a PC (Personal Computer).

The system consists of a controller, probe(s) and a control valve. There are optional indicators that can be added to provide additional information to the operator, such as air flow gauges, gas flow gauges, lights and audio. In most cases, you only need one probe, either bean or environment. Most systems use only a single probe to control the roaster. Although there can be a second probe, it will only provide information on another temperature.

Hardware

Valves—In most cases, you will have a main valve, used to control the flow of gas to a control valve, which is used to control the flow of gas to the burners. The main valve is the same as in the manual system, one that utilizes a pilot and flame sensor. The control valve can be of various types as stated above in the definitions; butterfly, solenoid, modulating or proportional. In any configuration, the valve will be controlled by a controller, that determines how long the valve will be open, or to what degree the valve will stay opened.

If the system uses a solenoid valve the controller will determine what percent of the cycle the valve is open and closed. The cycle is the time duration before the next iteration of output. For example, the cycle time that should be used for a mechanical valve, solenoid, should be at least 5 seconds. If you use a shorter time, you will prematurely wear out the valve. Mechanical valves can only last X-number of open/close cycles, having them open and close very fast will cause them to fail quickly. If you set a cycle time of 1 second, that means the valve will open and close every second. During a 15 minute roast, the valve will open and close 15×60=900 times per roast and at three roasts per hour, 2700 cycles, 7 hours a day=18,900 times. If the valve is rated for 1,000,000 cycles, the valve may fail after 53 days of roasting. If the cycle time is set for 5 seconds, 15×60/5×3×7=267, which is 3,745 days. This same logic can be used when talking about a modulating valve. Modulating valves are mechanical valves too. They are usually designed to last longer than simple solenoid valves. The other difference is that you are switching between a high and low flame setting, where solenoid valves switch between fully open and completely closed.

In the case of a butterfly or proportional valve, the actual movement of the valve is mechanical, but electronically controlled. A mechanical valve either slams open or slams closed, causing forceful wear on the components. The coil used to open the valve is always at full force. With a butterfly or proportional valve the signal sent to the signal conditioner makes the valve move in gentle increments. The controller will determine the output, the output is scaled to the signal range, which is then sent to the signal conditioner, which then sends the corresponding voltage/current to the valve, which then adjusts the valve position. Depending on the type of valve, you may be able to adjust it in ½ second cycles, the faster the cycle the smaller the adjustment, the quicker the system can adjust to stay on track.

Probes—All controlled systems will utilize at least one digital probe, and may use a second digital probe or a mechanical probe. Placement of these probes will determine how the system controls the roast process, and how repeatable the process will be. If the probe is positioned in the environment, then it will control by the environment, if in the beans, then by bean temperature, provided the probe is always in the bean mass. If your bean probe is located to high in the drum, when you roast small loads you may not be actually reading bean temperature, it will be an average of bean and environment.

The most common digital probes used are either type J or K, and in some cases RTD's are used. That all depends on what the system engineer is trying to do.

Indicators—Various indicators are and can be used in control systems. Some are purely for providing information, others are used in the control logic, either in real time or prior to the start of the process. Some examples are: preheat reached, air flow, gas flow, real time temperature values and graphs, barometric pressure, humidity, room temperature, moisture content. Some to all of these can be used in a control scheme.

Some indicators are simply yes/no, on/off indications of state. Other indicators are numeric values.

Controller—The controller is the heart of the system. It is what takes in the information on the state of the process, and through its logic, determines what the required action should be. How should output be adjusted, has final temperature been reached, is the roaster ready to have the green coffee dropped in, should the burner be turner on.

Depending on the type of controller you have, off the shelf or a custom controller, will dictate what and how many input and outputs you can have. Some off the shelf controllers will be limited to only having temperature probes as inputs and 1 or 2 outputs.

Control Method (by Bean or Environment Probe)—The control method will also be dictated, to some degree, by the type of controller you are using. Most off the shelf ramping controllers can only interpret in straight lines between set points. They are also limited to the number of set points you can enter. This may limit you from controlling by bean temperature. Depending on the way you like to roast your coffee straight line temperature rises of the coffee bean temperature may not be desired, but this type of controller could be used. It is possible to have the environment ramp in such a way to get the coffee to roast as desired, given enough places to enter the set points to produce the rise in temperature you are looking for. But remember you will need to adjust the set points to change the environment temperatures when roasting different size loads. Another disadvantage of off the shelf controllers is that they are limited to the number of profiles they can save.

Custom controllers have the ability to have multiple types of inputs and outputs, which are only dictated by the hardware the designer uses. Custom controllers also require that the designer creates the logic used in controlling the roasting process. Since the logic is created, the design can use very complex algorithms to control the bean temperature without going in straight line between set points. They also are capable of storing more profiles than the off the shelf controllers. Some custom controllers are capable of real time graphs, on the fly changing of variables, printing out reports, logging all roast information, etc. Some systems are capable of having their programs updated, either remotely or on-site, some of them may require special software or hardware for changing the program.

Operation

Here are a few examples of how different control systems can be used to control the roast process.

Style 1—Controlling the environment temperature with an off the shelf controller. As an example, program the controller with set points that hold the environment temperature at 380° F. for 12 minutes, then ramp to 450° F. at 17 minutes and hold that temperature until turned off. This style will try and hold an environment temperature of 380 until 12 minutes have elapsed. Then it will divide up 70 degrees over a 5 minute period, 14 degree rise per minute, and ramp the environment temperature until it reaches 450° F. at 17 minutes. Then it will hold 450° F. until you stop the controller.

Style 2—Using a custom controller, you can program in either times or temperature values to change the output and or air flow of the system. For example start out with 100% output, at 2:30 minutes change output to 75%, at 8:00 minutes change output to 50%, at 12:30 minutes change out put to 80%, then at 14:00 minutes change out put to 100%. You may want to continually decrease output over the entire length of the roast. Depending on the system you may be able to manipulate the airflow at the same or different points that you change the out % to the burners.

Style 3—This method is again using a custom controller. You start by roasting manually, manipulating the output and airflow, which the system records and saves. Then you can go back and recall the data saved and use it to control the roast process. This process tries to mimic what the operator has done manually. Another variation on this could be recording the bean or environment curve and then using the curve to control future roasts.

Style 4—Uses a custom controller to control by bean temperature. The operator inputs the desired set points which the controller's logic uses to create a profile specific for each roast. The system uses the information the operator puts in along with real time data from the beginning of the roast to determine the optimal path to reach the desired set points. These set point profiles can be saved and recalled later. The system will use the profile set points along with the new data form the new roast to determine the optimal path for that specific roast, while trying to reach the same set points as the previous roast.

Data Logging, Report Generation, Quality Control:

Some other means of assisting the roaster with the roast process would include data logging equipment and report generation capabilities. Both of these do not actually do any controlling, but will provide feed back to the roaster to help in the process.

Data loggers come in a variety of forms; chart recorders, PC programs, manually recording time& temperatures and various combinations.

The simplest and least expensive of data loggers is the manual method, where the operator records time & temperature on paper or in a computer spreadsheet. Although this is appealing, one needs to keep in mind that it is sometimes difficult to perform both record keeping, and making sure the roast proceeds as desired.

Chart records are simply a piece of equipment that takes in a signal, in this case from a temperature probe, and moves a pen on a piece of graph paper while the graph paper advances. This is real similar to the way a lie detector test or an EKG test is recorded. The equipment is setup to scale the width of the paper between a minimum and maximum input signal that corresponds to a min and max temperature value. Then the paper is advanced, scrolled, at a time dependent rate. The result is a line plotted on a time vs. temperature graph. Some of the more expensive machines can be connected to a computer to record the data in a digital format. Depending on the equipment and software the manufacturer supplies may or may not require additional work to get the recorded data in a format that you can use.

The next type of data logger is one that is custom designed to run software on a PC and interface with hardware that conditions the temperature probe output. This type of data logger is designed to display temperatures and time on a graph on screen, in real time mode, so the operator can use the information immediately. These systems will usually display and record the data without additional effort from the operator. The systems should be capable of printing out the graphs if desired, or allow the operator to recall previous data files for comparison.

### SUMMARY OF THE INVENTION

The inventive process comprises micro-processing means utilizing a coffee roaster control algorithm for controlling the roast process of coffee beans. The algorithm utilizes curve fitting techniques to calculate polynomial coefficients used in generating a smooth curve to control the coffee bean temperature during the roast process. Through the use of multiple set points and actual historical data, the polynomial coefficients are generated. The coefficients are then used to plot a graph that indicates the path the roast process will try and maintain.

The process is started by inputting profile data points that consist of time-temperature points, as well as a hold temperature value that is used to determine when the polynomial curve stops re-calculating and holds the last calculated values for the remainder of the roast process. The system is started. Using a predefined or desired pre-heat temperature value, the roaster is heated until it reaches the pre-heat temperature. Pre-heat temperature is maintained until the system senses a drop in temperature that triggers the next sequence of logic. The logic also utilizes a temperature off-set value that ensures a smooth transition into the polynomial curve once the hold temperature value has been reached. Prior to reaching the hold temperature value, the system maintains a calculated output percentage based on the systems PID settings and off-set value. While the bean temperature is below the desired hold temperature, the polynomial curve is continuously updated. Once the hold temperature is reached, the polynomial stops re-calculating. The system attempts to maintain the coffee bean temperature the same as the curve value for that instance in time. The system utilizes multiple PID array schedules in the calculation of output. Output is calculated based on the difference in curve value and bean temperature value, along with the PID settings for the temperature range using industry standard PID algorithm calculations. Once the final desired temperature is reached the system turns off the roaster burners and indicates to the operator, or through automation, that it is time to release the coffee from the drum. If during the roast process the operator opens the drum door and releases the coffee from the drum, the system will process the drop in temperature and end the roast sequence.

Some of the unique characteristics to the system are the use of curve fitting techniques, the use of polynomial curve fitting techniques, the use of desired set points along with historical data in co-efficient calculations, the generation of a polynomial curve to control the temperature profile of the coffee bean temperature during the roast process, the use of media(coffee bean) temperature in determining when the coffee is released into the drum to start the control logic, the use of media temperature rise to determine calculation of the polynomial curve, the use of media temperature in determining when to stop re-calculating the polynomial curve, the use of media temperature to determine when to stop applying maximum output, the use of multiple PID gain schedules, the use of multiple PID gain schedule arrays through out the roast process, the use of media temperature to determine when to change PID setting in the array, the use of media temperature to determine the operator ending the roast process, the use of media temperature probe to control the process, the automatic data log reaction at end of roast process, the automatic printing of screen, capturing the process at the end of the roast, the logic allows for various batch sizes to be roasted using the same roast profile, the system logic automatically takes into account changes in: environmental conditions, ambient bean temperature, bean moisture, humidity, barometric pressure, and air flow, and the system utilizes seamless transfer between manual and automatic burner control.

More specifically, the claimed process is a coffee roasting control process comprising:

providing a coffee roaster system, said system including programmable micro-processing means for generating, plotting and monitoring a predetermined time and temperature profile to control the roasting process of a selected origin or blend of coffee beans, and display means for visualizing and monitoring desired roasting parameters utilized during the roasting process;

providing means for printing a report and data associated with the roasting process of the selected coffee beans;

inputting a desired polynomial profile consisting of predetermined time and temperature data corresponding to the selected coffee beans to be roasted;

using a desired pre-heat temperature value, turning on a heating source of a coffee roaster until a roasting environment reaches the desired pre-heat temperature value based on quantity of said coffee beans;

changing desired pre-heat temperatures based on said quantity of said coffee beans to achieve a consistent equilibrium point for all quantities of coffee beans for the profile;

adding the coffee beans to said roasting environment;

monitoring a bean temperature and an environment temperature over time as said coffee beans are roasted during the roasting control process;

maintaining a heat output of the heating source while calculating a polynomial curve corresponding to the desired polynomial profile, based on a change in temperature of the coffee beans during the roasting process and at pre-determined time intervals until the temperature of the coffee beans reaches a pre-determined hold temperature value;

adjusting thereafter said heat output so that the bean temperature generally follows the polynomial curve corresponding to the desired polynomial profile; and

turning off the heating source when the temperature of the coffee beans reaches a desired final temperature.

Definition of Equilibrium point: The phase of the process when the bean temperature probe and the coffee beans have equalized in temperature values. When coffee beans are first released into the roasting environment, they are at room temperature, the bean temperature probe is at an elevated temperature; pre-heat temperature. The coffee beans are rising in temperature, while the bean probe is decreasing in temperature, when the bean probe reading stops decreasing in temperature and starts increasing in value, is the equilibrium point. The time it takes to reach this point is consistent regardless of quantity of coffee beans. Therefore keeping this temperature value consistent is essential to achieving a consistent profile path for all selected origins of coffee beans, regardless of quantity. Consistent profile paths are a key element to consistent roast processes of the same selected origin of coffee beans, regardless of quantity.

The process further comprises printing a report of the roasting process; digitally saving data related to the roasting process for the selected coffee beans roasted. The desired pre-heat temperature is maintained until the coffee roaster system senses a drop in temperature that triggers a next sequence of logic that utilizes a temperature off-set value that ensures a generally smooth transition into the polynomial curve once the hold temperature value has been reached.

Prior to reaching the predetermined hold temperature value, the coffee roast system maintains a calculated output percentage based on Proportional Integral Derivative (PID) logic controller settings. While the bean temperature is below the desired hold temperature, the polynomial curve is continuously recalculated to be updated. Once the desired hold temperature is reached, the polynomial curve stops recalculating and the system maintains the coffee bean temperature so as approximate the desired polynomial profile corresponding to specific instances in time required for roasting the selected coffee beans.

When the desired final temperature is reached, the system automatically turns off the heating source and provides indication that it is time to release the roasted coffee beans from the roasting environment. The system further monitors one or a combination of ambient bean temperature, environment temperature, bean moisture, humidity, barometric pressure and air flow.

The polynomial curve is calculated based on predetermined time-temperature data point or points and actual time-temperature data point or points specific to the current roast process and/or the polynomial curve is defined entirely by predetermined time-temperature data points.

The actual time-temperature data point or points take into account additional variables that affect the roast process, said variables including an initial coffee bean temperature, a coffee bean moisture content, an external environment temperature, an external humidity, a gas pressure to the burner, a coffee bean density, all of which affect an initial rise in temperature while the burner is being held at a constant output until the hold temperature value is reached.

A coffee bean temperature probe is positioned so as to consistently monitor said coffee bean temperature regardless of quantity of coffee beans being roasted.

The coffee roasting control system comprises:

a coffee roaster system, including a heating source for providing heat to a roasting environment of said coffee roaster system;

the system further comprising programmable micro-processing means for generating, plotting and monitoring a calculated time and temperature profile to control the roasting process of a selected origin or blend of coffee beans, and display means for visualizing and monitoring desired roasting parameters utilized during a roasting process of said selected coffee beans to be roasted;

said micro-processing means further comprising control temperature monitoring and operational data processing means, said control temperature monitoring and operational data processing means including:

means for monitoring a temperature of coffee beans loaded in the roasting environment of said coffee roaster system and a roasting environment temperature;

means for calculating during the roasting process a polynomial curve corresponding to a desired polynomial profile, based on a change in temperature of said coffee beans during said roasting process and at pre-determined time intervals, beginning from the time of a designated initial measurement of the temperature of said coffee beans until the time the temperature of said coffee beans attains a pre-determined hold temperature;

means for transmitting monitored measurements from said means for monitoring the temperature of coffee beans loaded in the roasting environment of said coffee roaster system and the roasting environment, to said means for calculating during the roasting process the polynomial curve;

means for inputting and/or transmitting to said means for calculating during the roasting process the polynomial curve, coffee roasting profile data including time-temperature points at the predetermined time intervals, said hold temperature, and a desired final temperature; and

heat output control means for controlling the heat output of the heating source of said coffee roaster system by reference to said polynomial curve and said roasting profile data wherein the heat output is held to a constant maximum value until the temperature of the coffee beans attains the hold temperature value, and thereafter is adjusted so that the temperature of the coffee beans at specific time intervals approximates the temperature along the polynomial curve, until the temperature of the coffee beans reaches the desired final temperature, at which time the heat output is reduced to zero.

The system further comprises means for automatically turning off the heating source when the desired final temperature is reached, and for providing indication to an operator that it is time to release the roasted coffee beans from the roasting environment.

The control temperature monitoring and operational data processing means further monitors one or a combination of ambient bean temperature, environment temperature, bean moisture, humidity, barometric pressure and air flow.

The polynomial curve is calculated based on predetermined time-temperature data point or points and actual time-temperature data point or points specific to a roast process to be implemented and/or the polynomial curve is defined entirely by predetermined time-temperature data points.

The actual time-temperature data point or points take into account additional variables that affect the roast process, said variables including an initial coffee bean temperature, an coffee bean moisture content, an external environment temperature, an external humidity, a gas pressure to the burner, a coffee bean density, all of which affect an initial rise in temperature while the burner is being held at a constant output until the hold temperature value is reached.

### BRIEF DESCRIPTION OF THE DRAWINGS

In the accompanying drawings:

FIG. 1 is a representation of what a portion of the gas train piping may looks like in a roaster control cabinet depicting ball valves, gas supply line through a main valve, a control valve and the lines to the burners;

FIG. 2 depicts an example of a User Interface—Profile Details Tab screen shot;

FIG. 3A is a screen shot depicting an example of a profile curve that needs to be avoided;

FIG. 3B is a screen shot depicting an example of a more desirable curve, where the temperature is always climbing until it reaches the final time & temperature point;

FIG. 3C is a screen shot depicting an example of what the curve may look like with a higher Hold Temperature;

FIG. 4 is an example of the configuration tab screen shot;

FIG. 5 is a screen shot of an example of a profile tuning tab;

FIG. 6 is a screen shot of an example of a print and screen tab;

FIG. 7 is an example of a screen shot of the Roast Degree Bar Tab and is a graphical representation of the roast degree by common names at their common temperatures;

FIGS. 8A and 8B, FIG. 8B being a continuation of FIG. 8A on a second sheet, is a schematic representation using a flow chart, summarizing the inventive process;

FIG. 9a is a perspective end view of a typical probe arrangement for bean and environment temperature monitoring;

FIG. 9b is an cross-sectional view of FIG. 9a depicting the probe arrangement; and

FIG. 10 is an electrical schematic of an example of a typical electrical circuitry for the present inventive system and process.

### DETAILED DESCRIPTION OF THE INVENTION

The following describes different embodiments of the software portion of the invention, the data logging version and the roaster control and data logging version. Collectively, the software and associated firmware may also be called microprocessing or processing means to perform the various settings, monitor the heating process, operate the roaster system, print charts, store data, input data, etc.

The data logging system is used to log the roast data from each roast. It will log environment temperatures and bean temperatures, to a file that is saved in a subfolder with the name of the profile indicated in the “Profile Loaded” text field.

The system is designed to control the roaster and log the roast data for each roast. The system uses profile inputs to generate a profile curve, which the system uses in controlling the output of the burner. The profile inputs are supplied by the roasting person, which determines the time and temperature points the system uses in determining the profile curve.

Both systems are PC based control systems. The programs typically run on a WINDOWS® based PC which communicates to remote I/O hardware that controls reading the temperature probes and controlling the outputs which control the roaster burner and/or optional stir, door and after burners.

The software has settings which allow for printed records of each roast at the completion of the roast. By turning on this feature and connecting a printer to the computer, a hard copy printout of the roast will automatically occur when the roast is completed. You have two options of the type of reports you can select, a standard report which will print a report consisting of a screen shot of the operator interface and a second page which is a blank cupping form. The second report option utilizes MICROSOFT WORD® to print out the report. Using the second method allows you to scale the graphics printed to fit on one page if desired.

Both systems automatically log the roast data to a CSV type file which can be opened in a spreadsheet or with the bonus software Log Reviewer. The file contains four columns, Time (secs), set point, environment temperature, and bean temperature. These files are typically saved in a sub-directory named after the roast profile name, ex. Colombian, would be saved in, for example,

c:\Program Files\ProfilePlusDCQ\Colombian\ColombianRoastData08032004-0835PM

The system is designed to automatically take the profile name and add to it “Roast Data”, the date and time of the roast, then puts it in the sub-directory of the profile. If the sub-directory does not already exist, it will create it prior to saving the file.

When the roast reaches 10° F. before final temperature the Turn Stir light will come on and the beeper will sound, reminding the operator to turn the stir and cooling tray blower motor on (in another embodiment, with the stir and door options, these will be turned on automatically at 8° F. before final temp). Then at final temperature, the burners will be turned off, the Drop Door light will come on and read Drop Door Open, which indicates that you have reached the final temperature and need to open the drum door releasing the coffee into the cooling tray (again if you have the door option, this will be done automatically). After all the coffee has exited from the drum, close the door (if you have the door option, press/click on the button on screen to close the door).

Example of Running a Roast

As an example of how a roast may be run, the operator would start by turning everything on and starting up one of the programs associated with one of the preferred embodiments and for reference, it will be called the “ProfilePlusDCQ™” program. Another program may be referred to as the “Profile DCQ Data Logger” Either select your profile, if already created, or enter the new Profile information and save the Profile.

For the ProfileDCQ™ Data Logger, once the roaster reaches preheat, click or depress (or otherwise activate) the “Start” button. Note: a touch screen is ideal or preferred for operating the system through its process. When you push on the start button, the system will start recording and displaying the information. When you activate or depress the “Stop” button, the system will stop recording and print the screen shot if “Printing” is on (when desired).

For the ProfilePlusDCQ™ control system, click or depress (or otherwise activate) the “Start” button. The system will light the burners and bring the roaster up to preheat temperature. Preheat temperature is based on the Environment temperature probe. This is the only time the system uses the Environment probe in the control logic. Once the roaster is at preheat temperature, an indicator light will come on (typically green), signaling that the roaster and system are ready for the green coffee to be dropped into the drum. When the system sees a drop in the bean temperature and is below the final temperature, the system will start to log and display the roast information, the green light will turn off and the data logging indicator light will turn on. The system will watch for the equilibrium temperature between the green coffee and the bean temperature probe. This is the point at which the bean probe temperature starts to climb again. The system will start to generate the profile. The system will continue to recalculate the profile curve until the bean temperature reaches the “Hold Temp” value (at this point the curve will be locked in). The system will calculate the burner output, trying to maintain the bean temperature the same as the profile curve temperature. There may be some over shoot or under shoot in bean temperature while the roast is running. Slight over/under shooting is acceptable, trying to stay with in a couple of degrees. If the difference is large, this is most likely due to incorrect PID settings. When the roast reaches the point that it is 10° F. below the final temperature, an alerting indicator such as the beeping of a control cabinet beeper will sound. If the door and stir option is on the system, at about 8° F. below final temperature, the stir and cooler blower will turn on. When the bean temperature reaches the final temperature, the system will shut off the burners and open the drum door (if the optional door opener is installed). All of the roast information will be saved to file on the hard drive and if the “Printing” function is ON, a screen shot of the main operator interface will be printed. When the Start button is visible (typically lighted), the roaster is ready for the next batch. If you have a low preheat value set, there will be a “WAIT” indicator displayed (typically yellow) over the Start button. The WAIT indicator will disappear when the environment temperature is 20° F. below the preheat temperature.

System and Power Requirements

The system typically requires 110 VAC power, standard wall outlet but may be adapted for any local power requirements of various countries.

The PC or processing means requirements are typically as follows: Pentium 3 850 MHz equivalent or better; 256 Meg RAM 20 Gig hard drive; 15″ Monitor with a minimum resolution of 1024×768; CD drive; COM port #1 open.

You will need to plug in the Roaster, remote I/O hardware and Computer. The suggestion is to plug the roaster into a separate circuit, from the remote I/O hardware and the computer. The Computer can be plugged into the outlet bank in the control cabinet.

Installation

Hardware—The system consists of a hardware cabinet, roaster and PC.

Cabinet installation—Profile DCQ data logging—The cabinet can be placed on any solid surface or mounted on the wall if desired. Connect the temperature sensors to their corresponding jacks.

ProfilePlus DCQ control system—Place the cabinet in close proximity to the roaster. Connect the wire harness plug to the control cabinet and secure the latches to hold the plug in place. Place your computer monitor on top. The receptacle is powered when the power switch is turned on. The switch utilizes a key to turn on and off. When power is ON the green indicator light is on.

Connect the serial cable to the computers COM port 1.

Connect the hardware cabinet's power cord to a wall outlet.

Turn on the computer.

Software—Insert a CD into the computer that includes installation software. The CD will automatically bring up an installation menu allowing you to choose which software installer to run. Select the software you wish to install, click on the Install . . . text, this will launch that software's installer. Follow the prompts the installer gives you, installing everything into their default locations. When finished click on the Exit text.

Example of Program Names are: C:\Program Files: ProfilePlusDCQ™, Roaster Label Printer, and Log Reviewer

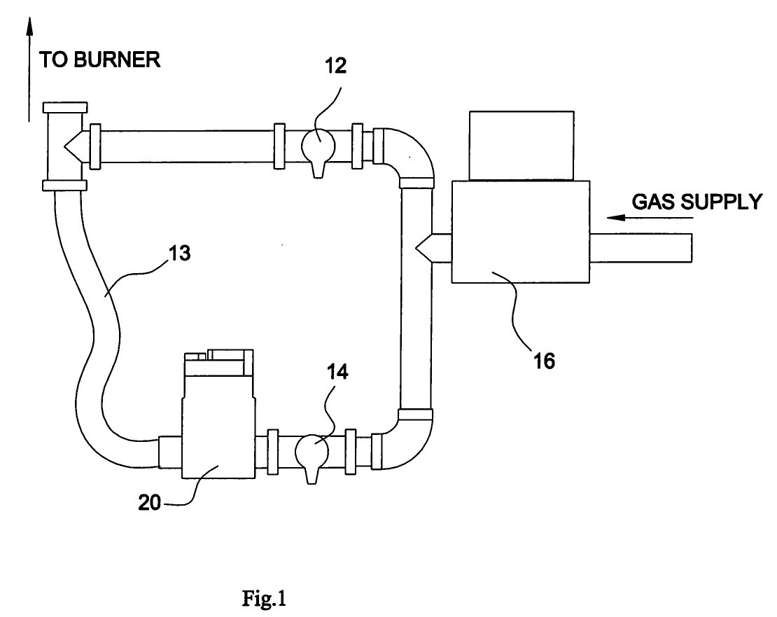

Roaster Control Configuration—You will need to make sure the ball valves 12, 14 inside the control box on the roaster are in the correct position depending on if you are roasting using the inventive process herein or if you are roasting manually. FIG. 1 is a representation of what the gas train may look like in the roaster control cabinet. If you are going to roast manually, the upper ball valve 12 needs to be inline with the pipe, while the lower ball valve 14 needs to be perpendicular to the pipe. If you are going to roast with the present invention control system, the ball valves need to be just opposite, upper perpendicular, lower inline. Other typical components depicted are gas supply main valve 16, flex line 18 and control valve 20.

User Interface—Profile Details Tab

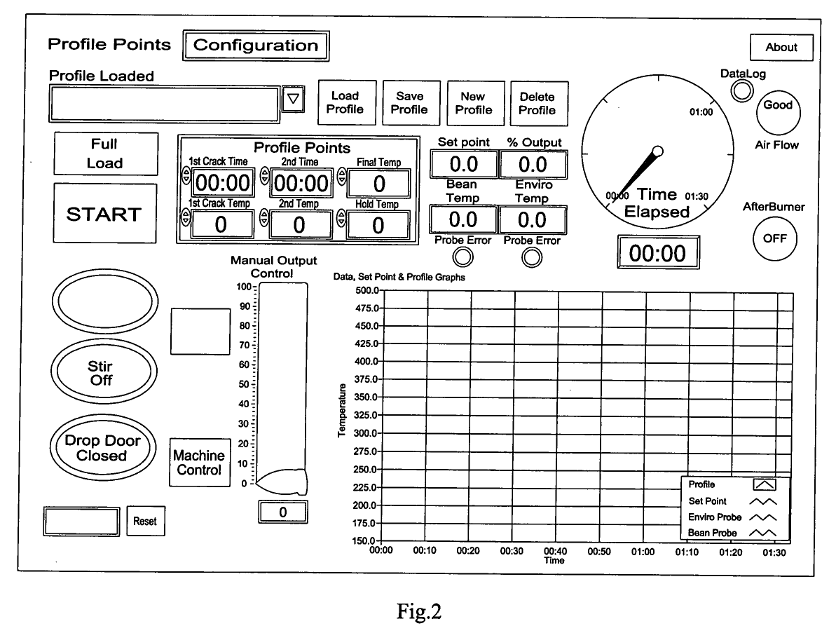

The following are the descriptions of the graphics on the user interface, Profile Details. Referring to the example of a screen shot shown in FIG. 2, there are two main tabs, Profile Details and Configuration. All descriptions will be based on using a standard computer monitor, meaning the use of a mouse to click and select. If you are using a touch screen, all items can be selected by touching the appropriate box/button. Boxes will pop-up an on-screen number pad or keyboard that is used to enter the information.

Although the profile lines depicted in the screen shots disclosed herein may be shown as a single black line, they are typically differentiated by lines in different colors or in various configurations of sequential combinations of lines and dashes.

All items are pertinent to the present invention control system and items marked with * also pertain to the data logging part of the system described above. The main differences between the two, is that the data logging system only logs the data, and does not do any controlling. data logging function requires that you click the Start button when you want to start logging the data. The system will also generate the profile curve based in the profile information entered. You can use this curve as a guide to follow if you desire. The system preferably is programmed to automatically stop recording.

The Profile Details tab is where all the roasting operation is performed. This is the main operator interface. All functions required to roast are located on this tab.

The profile loaded* text box is the text box that is used to select the profile for the roast. You can use the drop down arrow on the right to display the list and then select the profile from the list.

The load profile* button is used to load the profile settings after the Profile has been selected in the Profile combo box.

The save profile* button is used to save any changes made to the Profile settings. After making our changes in the boxes in the Profile Points, click this button to save the changes for future retrievals.

The new profile* button is used to create new profiles. Enter the new Profile name in the combo box and make any changes to the Profile Points you desire, then click on this button. A New profile will be created with the new name and Profile points. Now if you click on the drop down arrow, you should see the new Profile in the list.

The delete profile* button will delete the Profile visible in the Profile Loaded box. It will remove the Profile points file and remove it from the selection list.

The full load/partial load button is used to select either Full or Partial load preheat temperature setting. The settings are located on one of the configuration tabs sub-tabs, which will be described later. You will need to determine what load size is the changing point. Every machine and roast style will have a different change point, for example, on one machine, the change point may be a 3 pound load. Everything above 3 pounds, the operator would use a full load preheat temperature, anything below 3 pounds, the operator would use a partial preheat temperature. The reason behind the different temperatures is to keep the equilibrium temperature the same, regardless of load size. If the equilibrium point is below this range, the equipment will struggle to stay on the profile. If it is too high, the profile will tend to be flat, not allowing for much difference in the profile curves.

The Start/Stop* button is used to start and stop the roast profile. After selecting and loading the profile, and selecting full or partial load preheat setting, start the roast. If you need to stop the roast before reaching your final temperature, you can either press the Stop button to turn off the burner or you can open the drum door and allow the coffee to exit into the cooling tray. By releasing the coffee from the drum, the program will automatically sense the drop in temperature and stop the roast and turn off the burners. The Wait button will be displayed when the preheat value is lower than the actual environment temperature. When the environment temperature is 20° F. below the preheat temperature value, the Wait indicator will disappear. For the data logging system, you will need to click the Start/Stop button to start logging and to stop logging. Clicking the Start button will start logging immediately, and clicking the Stop button will stop immediately.

The Profile Points* are the heart of the profile system. These are the main inputs that control the generation of the profile curve (the path the roaster will follow). The points that you enter are Time & Temperatures you desire the roast to hit along the profile.

First crack Time and Temperature values can be used as indicated, when you want to reach first crack, or can be any point, time & temperature, that you desire to hit along the curve.

Second Time & Temperature is the second point along the curve you desire to hit. This could be second crack or final time & temperature.

These two points are used along with the actual roast points to create the profile curve. The actual points determine how the coffee is responding to the heat applied in the beginning of the roast. The faster the climb in temperature, the steeper the profile curve will be. This helps to take into account changes in moisture, ambient temperature, load size, etc.

Final temperature is the final temperature you desire the roast to reach. Once this temperature is reached, the profile system will shut off the burners, and indicate it is time to open the drum door to release the coffee into the cooling tray. If you have the optional door opener, the system will do this automatically.

The final, and somewhat critical input value, is the Hold Temperature. The hold temperature is what is used to allow the profile curve to keep redefining itself. The curve will keep redefining until the bean temperature reaches the hold temperature value. You will notice that the curve starts out as a gradual climb to the points desired. But as it keeps redefining, the curve changes shape to one that has a steeper climb in the beginning and starts to flatten out before increasing in steepness again at the end of the roast. By changing the Hold Temp, you change the definition of the curve. There is a minimum value that has to be entered, which is machine specific because of installation differences. This minimum value is determined at the point at which the curve no longer has any points above final temperature prior to the final temperature/time desired. In other words, if the curve increases and peaks out then decreases again the hold temperature is too low. The profile must always increase along the complete path.

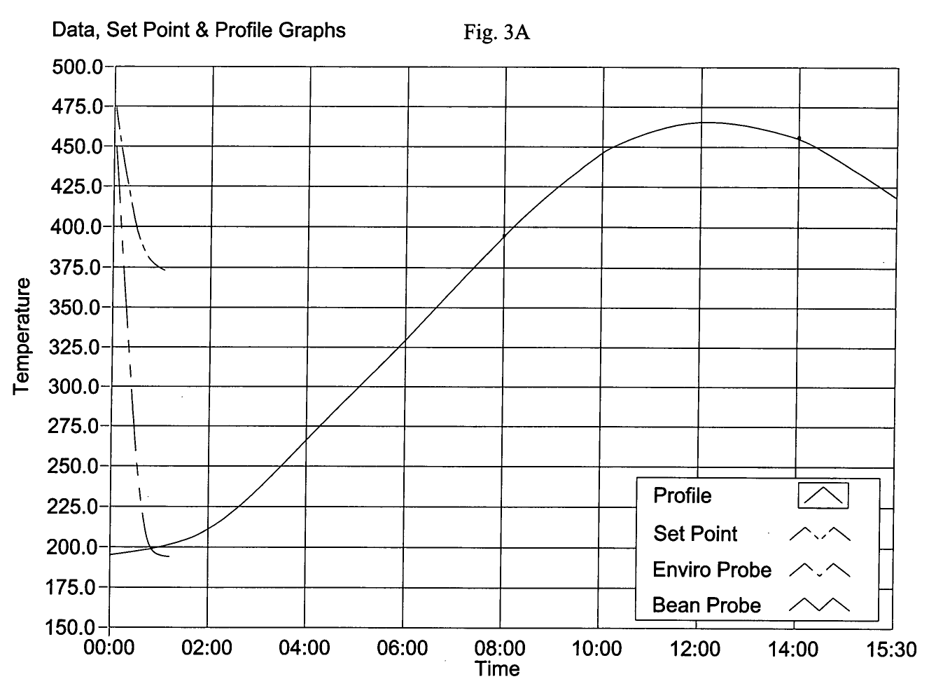

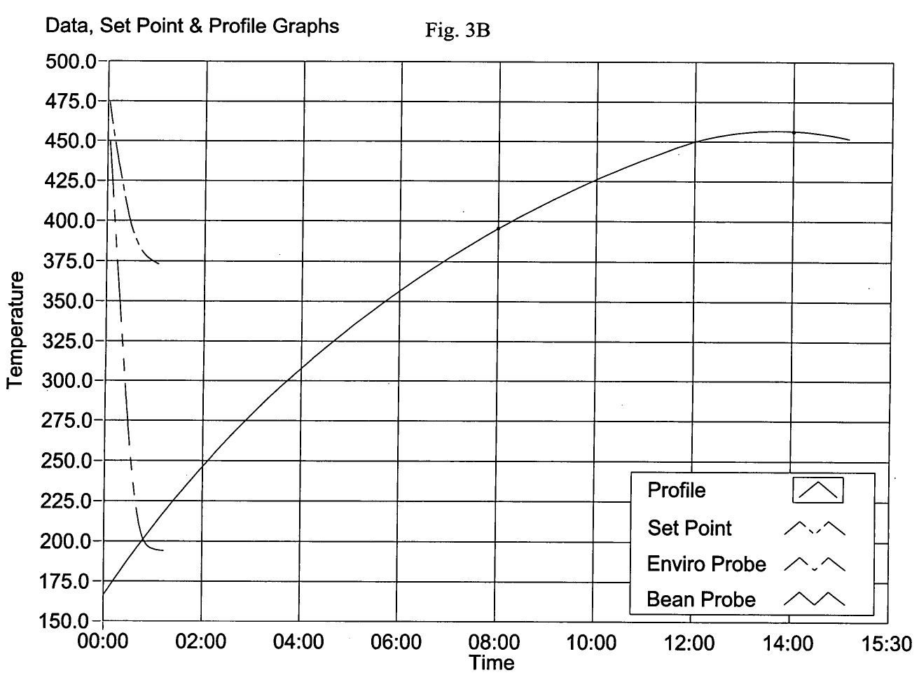

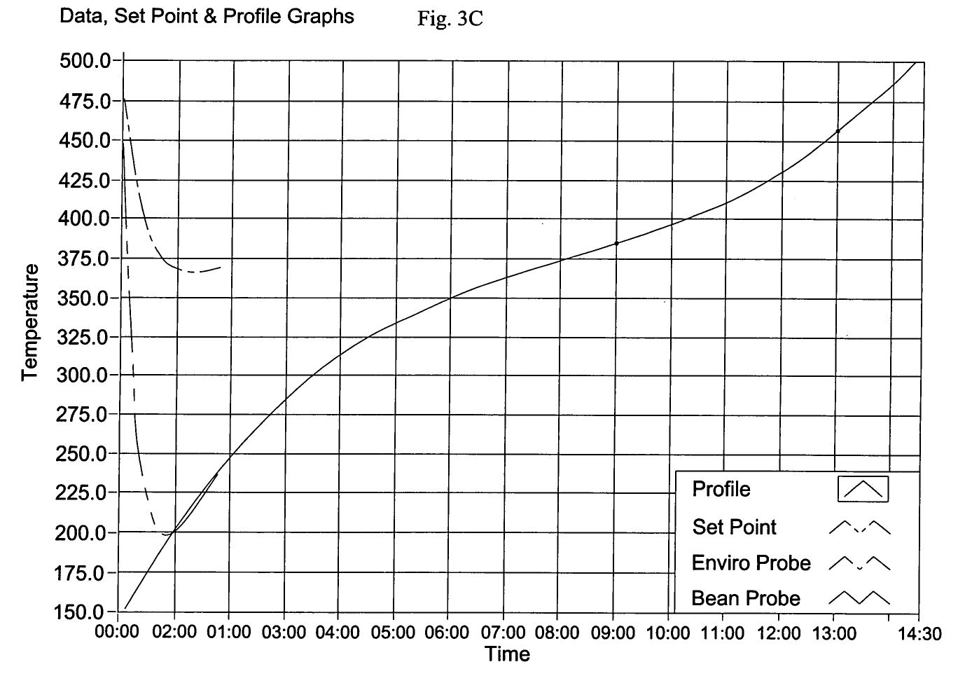

FIG. 3A is a screen shot depicting an example of a profile curve that needs to be avoided. You can see that the curve peaks before the second point, which in this case is the final time & temperature.

FIG. 3B is a screen shot depicting an example of a more desirable curve, where the temperature is always climbing until it reaches the final time & temperature point.

FIG. 3C is a screen shot depicting an example of what the curve may look like with a higher Hold Temperature. The higher the Hold Temp value, the more the curve will start to look like this.

The hold temp you define should allow the curve shape to fall in-between FIGS. 3B and 3C.

These values are used in the data logging system as indicators to help the operator make adjustments to the heat to reach the points desired.

The set point indicator displays the desired set point at that instance in time. When you are preheating the drum the set point will remain at the preheat temperature. Once the system starts logging data the set point will keep changing.

The % output indicator displays the output signal to the burner valve. The system continuously calculates what the output should be based on what the difference is between the set point temperature and the actual bean temperature.

The bean temperature* indicator displays what the actual bean temperature is at that instant in time. This is also the temperature used in the system logic once you drop the green coffee into the drum. Before that, the Enviro Temp is used to control the logic for preheating.

The Enviro Temp* indicator displays what the actual environment temperature is at that instant in time. The environment temperature is used when you click the start button to control bringing the roaster up to preheat temperature. The system will maintain the environment temperature at the preheat value until the green coffee is released into the drum. The temperature will cycle above and below the preheat temperature, until the coffee is released. Once the system sees the drop in temperature, and is 15° F. below the final temperature, the system will switch to using the bean temperature as the controlling value.

There are two Probe Error* indicators, one for each of the probes, bean and environment. If an indicator lights up, there is a problem with that probe. It could be a couple of things: the probe went bad, either shorted or opened, either case the probe failed and most likely needs to be replaced. Or that the hardware lost the connection with the probe.

The clock* displays the time elapsed since the beginning of the roast. Time starts once the system sees that the green beans have been loaded into the drum. The system knows this by seeing a drop in temperature.

The DataLog indicator lights up when the system starts to log the data, this also is when the clock starts to tick. This indicates that the system has seen the drop in temperature required to start controlling.

The air flow indicator is used to help watch what is happening in the drum environment. There is a setting in the configuration tab that allows you to adjust the value. The system monitors the average output between 5 minutes and 7.5 minutes, if the average output falls below the set value the indicator turns red with the words check blower. You will find in most roast profiles that there is a minimum output value that occurs, and if the average output falls below this, it is a good chance that the blower is not pulling the desired amount of air through the drum. So it is just a check to remind you that the blower might need cleaning.

There are other reasons that the average output could fall below the value, one is that the drum was preheated too high for the load. Meaning that there was sufficient energy stored in the drum to keep the bean temperature at or above the set point temperature. This is still not a good thing. The system will not be able to control the burner to keep the bean temperature on the profile. This is just a simple indicator, if you find it to be a bother, just set the value to 1 so that it always reads good.

The Afterburner indicator light is for systems with afterburners or catalytic converters. After the environment temperature reaches 250° F. or higher, the relay closes to allow the afterburner to turn on. If you do not have an afterburner on your system, the indicator just lights up.

The Roaster Ready* light indicates that the drum environment has reached the desired preheat temperature and is ready for the hopper load to be released into the drum. The system will oscillate about the preheat set point until the system sees the required drop in bean temperature to start controlling. Once the system sees the required drop in temperature, the indicator light will turn off, another indication that the system has started to control.

The Stir Light ON/OFF light indicates when it is time to turn on the stir, this is true for both the data logging system and the control system. The system logic turns the stir (and cooling tray blower) indicator On when the bean temperature is 10° F. below the final temperature stated in the Profile Points. This is to indicate to the operator to turn on the stir and cooler blower. Alternatively, the system can be adapted to be turned on automatically.

The Drop Door* light indicates when it is time to open the drum door and release the coffee into the cooling tray. This is true for both the data logging system and the control system. When the bean temperature reaches the final temperature, the burner is turned off and the indicator lights up. Alternatively, this can be set up to automatically open the door. Once all of the coffee is out of the drum, click on the button to close the door. If you click on the button to open the door while a roast is in progress, it WILL NOT open, the system logic dictates that the door should still be closed. Instead you must open the door manually. Once the system sees a drop in the temperature, it will automatically end the roast, turn the burner off and extend the door opener. This also applies to the systems that do not have the optional door opener. In other words, if you want to stop the roast prior to reaching the indicated final temperature, simply open the drum door and the system will stop when it sees the drop in temperature.

The Machine Control/Operator Control button applies to the control systems. When in the button indicates Machine Control, the system is in control of the burner output, adjusting as needed to try and stay on the generated profile curve. If the button is in the Operator Control position, then the operator is controlling the output to the burners through the position of the slider next to it. When the Operator is in control, it is as if he is running the roaster manually. The only difference is that the burner is adjusted digitally through the system interface instead of adjusting a valve manually. Remember during the preheat and roast stage, the system will not decrease or turn the burner off until the system has run through the complete cycle and reached the final temperature. So do NOT set the output to 100% and walk away from the roaster, the drum could easily over heat and possibly cause a fire or damage to the equipment.

The manual output slider is only active when in the Operator Control state. You can either slide the slider up and down or enter exact output values in the digital display just below it.

The graph portion displays real time trends of the set point, bean temperature, environment temperature and profile curve. The graph is updated every second. The graph will not start to display any trends until the system reaches preheat temperature and then sees the required drop in temperature. The graph starts at the same time the roaster ready light turns off, the DataLog light turns on and the clock starts ticking. All of the information displayed on the graph is saved to a file upon completion of the roast. This will be described later.

Roaster Configuration Interface

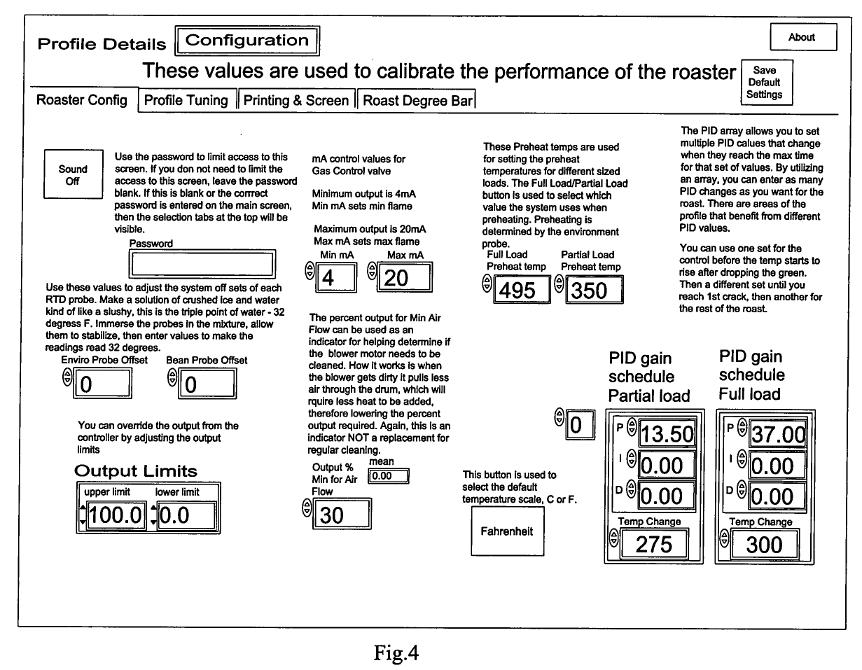

All controller system calibration and option selection takes place on the Configuration tab and sub-tabs. See FIG. 4 for an example of the configuration tab screen shot. Calibration settings are dependent on specific equipment and installation. The sub-tabs are broken up in to categories: Roaster Config, Profile Tuning, Printing & Screen and Roast Degree bar. The sub-tabs will be addressed one at a time. Each input box has a brief description above it to help with making adjustments, or describing what the input is for.

The Roaster Config tab holds all the roaster configuration inputs. These input need to be adjusted to calibrate the control system to the roaster. The settings are equipment and installation dependent. It will take some testing and adjusting to get the settings correct. Each roast will provide insight into the adjustments made, and help in determining how to adjust them further to reach the optimal calibration for the setup.

The sound* button is used to turn On/Off the sound capabilities of the system. The system may use wave files. When you turn the Sound On, the system compares the temperature to the file name, when it finds a match, it plays the wave file. The system makes a list of all the files in the sub-directory, removing the F.wav from the file name. It then compares the temperature to the list. When it finds a match it plays the file, for example, the temperature is 350, there is a file named 350F.wav, there is a match, so the file is played.

The probe offset* boxes are used to calibrate the system probes. The RTD's can be calibrated in the following manner (this only applies to RTD'S, it can not be used for thermocouples): make a mixture of crushed/shaved ice and water. Allow the mixture to sit for a few minutes, then insert the probes into the mixture. Allow the probes to stabilize, it should only take a few minutes. The probes should be reading 32° F., if they do not enter the difference in the corresponding Probe Offset box. Now the system is calibrated. For maximum accuracy, repeat this procedure every couple of months, or if you replace a probe. This can be done with the probe installed in the roaster as long as you can submerge the probe in the mixture, this is preferred, because the probe could be damaged if you try to remove it and replace it.

The Min mA and Max mA boxes allow the burner valve to be fine tuned. The valve's output is adjusted by a signal from the control system, this signal is a milliamp value between 4 and 20 milliamps. You can adjust these values to either lower the maximum output or increase the minimum output. If you find that the minimum flame is too low and would like it be higher, increase the Min mA value, likewise, if the high flame it too high lower the Max mA value to decrease the maximum flame. The logic will adjust to accommodate the new values when calculating the percentage out put to the valve. You can also adjust these values to make the system more responsive at the upper and lower limits. All of the valves have a small band at the upper and lower limits, where the output percentage changes, but you do not see a change in the flame. By adjusting these values you can make the system more responsive.

The two preheat temperature boxes, Full Load and Partial Load, are used to set the preheat temperature values that correspond to the Full Load/Partial Load button on the main interface. You can set these values to what ever you prefer, or what works best with you equipment, and load sizes. The maximum temperature you can enter is 525° F.

The temperature scale button is used to select which temperature scale you want to work in. This button will only affect the temperature values that are read from the probes and the graph scales. You must input all temperature values in the correct scale you are using. In other words all the Profile Point info must be inputted in °C. or °F. depending on the scale you have selected. If you use one scale and then switch to the other, you will have to edit the profile info or create new profiles with the correct scale values.

The output limit boxes are another way or an additional way to adjust what the burner can do. The PID logic constantly calculates what the percentage output to the valve should be. The percentage output is then converted into a milliamp signal sent to the valves signal conditioner. With these boxes you can also adjust the minimum and maximum percentage output. If the logic calls for 100% but you have limited the maximum output to 80%, then the system will only send an 80% signal. In most cases using one set of boxes or the other is sufficient, but you can use both if you desire.

The output % minimum for air flow box and mean box work in conjunction with the check blower indicator light on the main operator interface. This is where you adjust what the minimum output during 5 minutes to 7.5 minutes needs to be for the indicator to green.

Again the logic behind this is that during normal roasts with a clean blower, there will be a minimum output required during this time frame. This is because the air flow will be removing heat from the drum, and the profile will be requiring more to stay on the profile curve. If the air flow should decrease, because of a dirty blower, the output will drop because not as much heat is being drawn out of the drum there for requiring less heat to be added. This is just simple logic, and not extremely accurate. Again if you see that the indicator is always indicating to check the blower, or becomes a nuisance, you can set the value to a very low number, even zero, to eliminate the change in indicator stratus. This will not effect the control system in anyway.

PID Gain Schedule Array

There are two sets of PID gain schedules for larger roasters. If you are using a smaller roaster, 2-kilo size, the two PID gain schedules will be the same. For larger roasters, it has been found beneficial to have different PID gain schedule for partial and full batches. The selection between which set to use is tied to the batch size selector button on the main interface. The PID Gain principle was explained above and is incorporated by reference herein.

The difference between this PID array and most other PID controllers, is that the array gives you the ability to set different PID settings for different portions of the roast. You use the single box on the upper left of the array to add additional settings. The box located on the bottom of the array, called Temp Change, is used to set the temperature value that you want the PID settings to change to the next set. The temperature change value only applies once the bean temperature is past the equilibrium point, on the rise again. This usually occurs at or just after 1 minute. When the bean temperature reaches the value set in the temperature change box, it will go to the next set of settings. If there are no further settings, it will continue to use the previous set. I use three different sets on the roasters I have set up. The first set is mainly for the initial drop of green into the drum up to a low temperature value once past the equilibrium point, say around 250-300° F. This first set of settings always uses just a P value that is very aggressive. I want to keep the heat at maximum while the temperature equalizes and starts to climb. I then have a second set, P and I values, that change again around 390-400° F., the P value is usually 5-10 less than the initial value. On the third set the P value decreases again, usually by the same amount and the “I” value increases slightly. The following are examples of PID arrays I have used:

### EXAMPLE 1

First set P=35, I=0, D=0, Temp change=250

Second set P=29, I=5, D=0, Temp Change=395

Third set P=23, I=7, D=0, Temp Change=600 (stays on this set for the remainder of the roast)

### EXAMPLE 2

First set P=37, I=0, D=0, Temp change=300

Second set P=16, I=19, D=0, Temp Change=400

Third set P=14, I=18.2, D=0, Temp Change=600 (stays on this set for the remainder of the roast)

Profile Tuning Tab

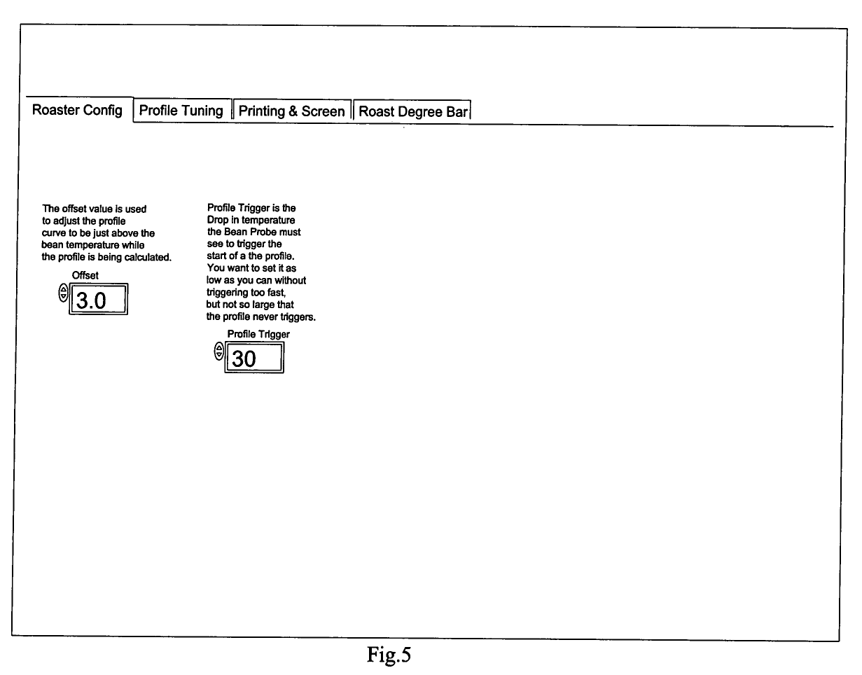

Referring to FIG. 5, which is a screen shot of an example of a profile tuning tab, the profile control system utilizes a set point that is just above the actual bean temperature up until the bean temperature reaches the profile Hold Temp. The system takes the actual bean temperature and adds an Offset to it. If the offset is high enough, this is usually only a few degrees, the output will remain at 100% until the Hold temperature is reached. If you lower the value, the output will be reduced. For example: a value of 3 may give an output of 100%, but a value of 2 may only provide an output value of 75%, thus softening the initial heat applied to the roast.

The Profile Trigger value is used in calculating the drop in temperature the system must see before it recognizes that the green load has been dropped into the drum. The system must see a combination of values to actually start the profile logging and controlling. It must see the Profile Trigger drop in temperature and the bean temperature must be 15° F. below the final temperature to actually start.

Print and Screen Tab

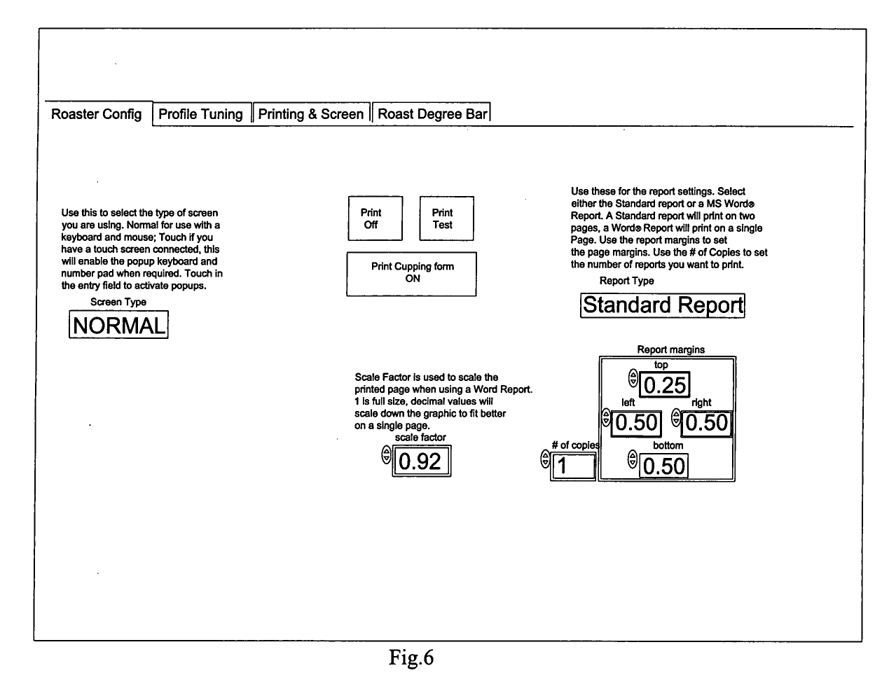

Referring to FIG. 6, which is a screen shot of an example of a print and screen tab, Use the Screen Type Drop Down* to select what type of screen you are using. For example, if you select Normal, then you will need to use a mouse and keyboard to interact with the user interface. If you have a touch screen, select Touch. This will enable the on screen number pads and keyboard. The number pads change based on what input type the box you tap on requires, so please pay attention to the format required for the particular input box. The keyboard will pop-up when required.

Referring to the print button*, if you select Print On, a report will be automatically printed at the end of the roast, that includes a screen shot of the main user interface, including Profile points, graph, time, etc . . . , and a blank cupping form. The Print Cupping form button is used to print or not print the blank cupping form with the auto print when the roast is completed. If the button is ON, then the form will print. If it is OFF then only the front panel will print.

The Print Test button allows you to print out a test report. You can use this to verify and adjust report settings.

Use the Report Type drop down* box to select the type of report you wish to print.

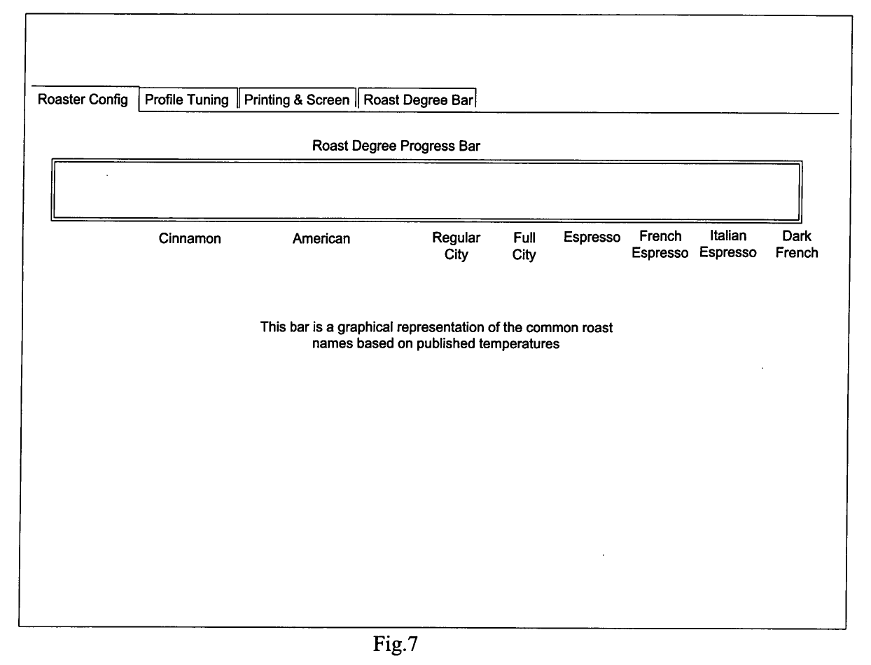

Referring to FIG. 7, which is an example of a screen shot of the Roast Degree Bar Tab and is a graphical representation of the roast degree by common names at their common temperatures. The fill bar gradually increases along the scale as the roast temperature increases. The fill bar also changes in color as the temperature increases. This is just a means of showing common roast names as the roast increases in temperature, something your customer may have an easier time understanding. In other words, the bar will progress along a designated portion of the screen shot.

The present invention can also be adapted so as to operate using a remote connection to processing or computer means.

The inventive process allows for looking at a previous roast, or comparing several previous roasts.

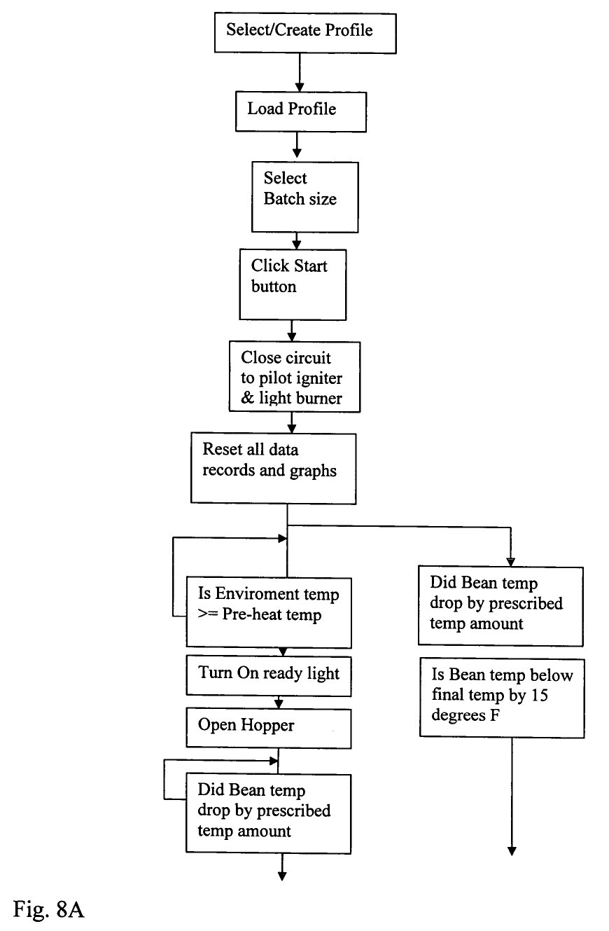

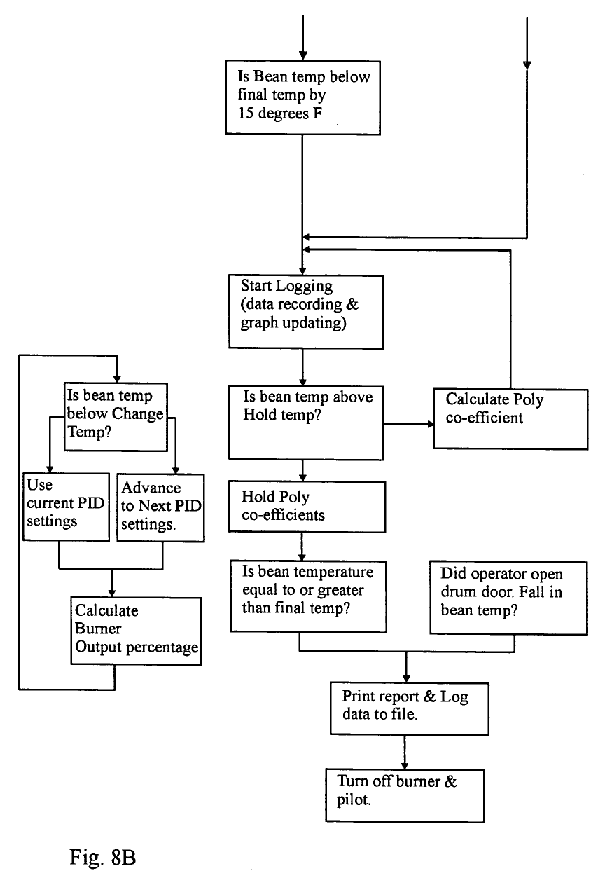

The above described process and/or controls can be summarized by the schematic flow charts shown in FIGS. 8A and 8B, FIG. 8B being a continuation of FIG. 8A on a second sheet.

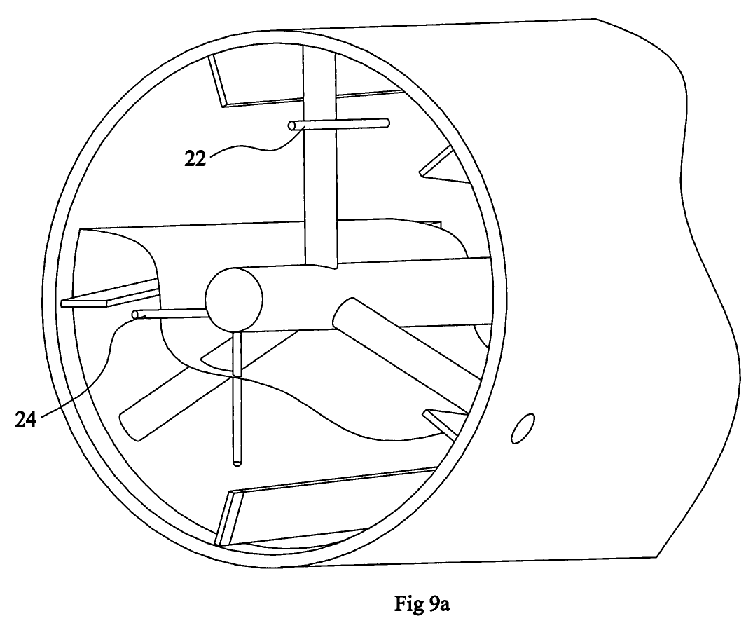

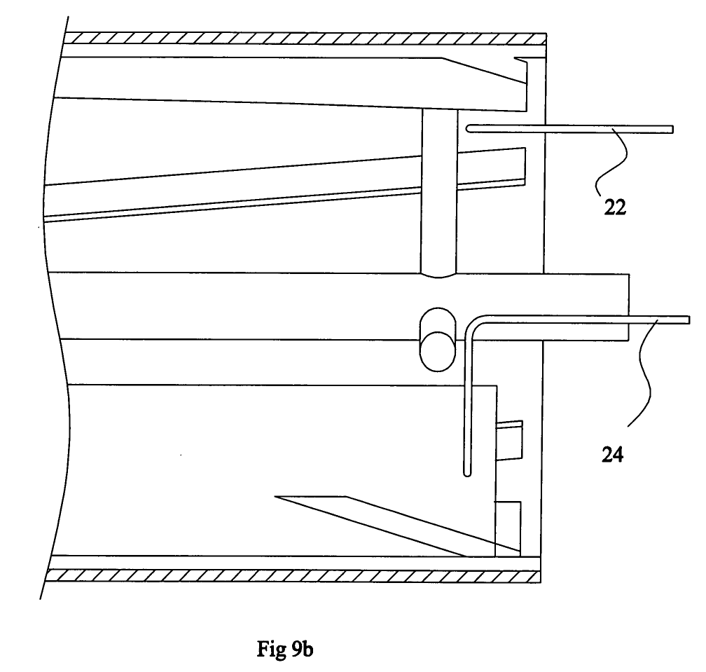

FIGS. 9a and 9b are views of a typical probe arrangement for bean and environment temperature monitoring. Environment probe 22 and bean probe 24 are shown in a typical arrangement.

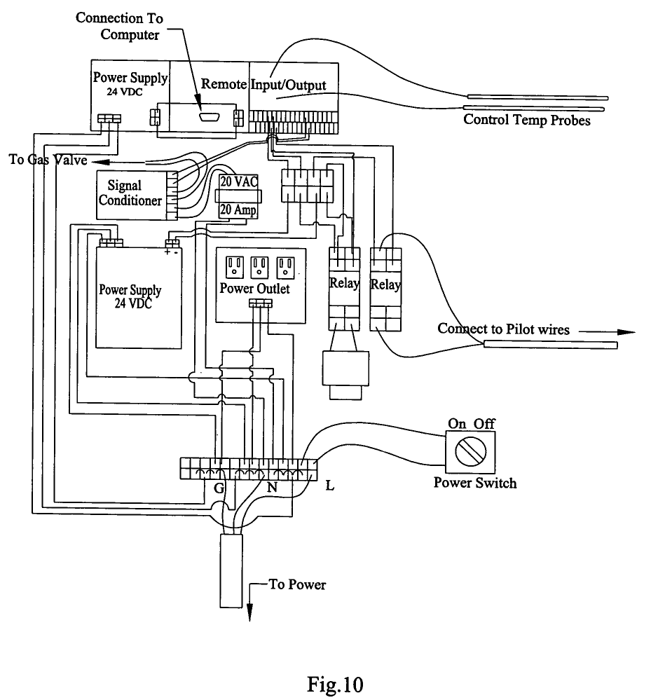

FIG. 10 is an electrical schematic of an example of a typical electrical circuitry for the present inventive system and process.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A coffee roasting control process comprising:
providing a coffee roaster system, said system including programmable micro-processing means for generating, plotting and monitoring a predetermined time and temperature profile to control the roasting process of a selected origin or blend of coffee beans, and display means for visualizing and monitoring desired roasting parameters utilized during the roasting process;
providing means for printing a report and data associated with the roasting process of the selected coffee beans;
inputting a desired polynomial profile consisting of predetermined time and temperature data corresponding to the selected coffee beans to be roasted;
using a desired pre-heat temperature value, turning on a heating source of a coffee roaster until a roasting environment reaches the desired pre-heat temperature value based on quantity of said coffee beans;
changing desired pre-heat temperatures based on said quantity of said coffee beans to achieve a consistent equilibrium point for all quantities of coffee beans for the profile;
adding the coffee beans to said roasting environment;
monitoring a bean temperature and an environment temperature over time as said coffee beans are roasted during the roasting control process;
maintaining a heat output of the heating source while calculating a polynomial curve corresponding to the desired polynomial profile, based on a change in temperature of the coffee beans during the roasting process and at pre-determined time intervals until the temperature of the coffee beans reaches a pre-determined hold temperature value;
adjusting thereafter said heat output so that the bean temperature generally follows the polynomial curve corresponding to the desired polynomial profile; and
turning off the heating source when the temperature of the coffee beans reaches a desired final temperature.

2. The process according to claim 1, further comprising:
printing a report of the roasting process.

3. The process according to claim 1, further comprising:
digitally saving data related to the roasting process for the selected coffee beans roasted.

4. The process according to claim 1, wherein the desired pre-heat temperature is maintained until the coffee roaster system senses a drop in temperature that triggers a next sequence of logic that utilizes a temperature off-set value that ensures a generally smooth transition into the polynomial curve once the hold temperature value has been reached.

5. The process according to claim 4, wherein prior to reaching the predetermined hold temperature value, the coffee roast system maintains a calculated output percentage based on Proportional Integral Derivative (PID) logic controller settings.

6. The process according to claim 4, wherein while the bean temperature is below the desired hold temperature, the polynomial curve is continuously recalculated to be updated.

7. The process according to claim 6, wherein once the desired hold temperature is reached, the polynomial curve stops recalculating and the system maintains the coffee bean temperature so as approximate the desired polynomial profile corresponding to specific instances in time required for roasting the selected coffee beans.

8. The process according to claim 1, wherein when the desired final temperature is reached, the system automatically turns off the heating source and provides indication that it is time to release the roasted coffee beans from the roasting environment.

9. The process according to claim 1, wherein the system further monitors one or a combination of ambient bean temperature, environment temperature, bean moisture, humidity, barometric pressure and air flow.

10. The process according to claim 6, wherein the polynomial curve is calculated based on predetermined time-temperature data point or points and actual time-temperature data point or points specific to the current roast process.

11. The process according to claim 6, wherein the polynomial curve is defined entirely by predetermined time-temperature data points.

12. The process according to claim 10, wherein the actual time-temperature data point or points take into account additional variables that affect the roast process, said variables including an initial coffee bean temperature, a coffee bean moisture content, an external environment temperature, an external humidity, a gas pressure to a burner, a coffee bean density, all of which affect an initial rise in temperature while the burner is being held at a constant output until the hold temperature value is reached.

13. The process according to claim 1, wherein a coffee bean temperature probe is positioned so as to consistently monitor said coffee bean temperature regardless of quantity of coffee beans being roasted.

14. A coffee roasting control system comprising:
a coffee roaster system, including a heating source for providing heat to a roasting environment of said coffee roaster system;
the system further comprising programmable micro-processing means for generating, plotting and monitoring a calculated time and temperature profile to control the roasting process of a selected origin or blend of coffee beans, and display means for visualizing and monitoring desired roasting parameters utilized during a roasting process of said selected coffee beans to be roasted;
said micro-processing means further comprising control temperature monitoring and operational data processing means, said control temperature monitoring and operational data processing means including:
means for monitoring a temperature of coffee beans loaded in the roasting environment of said coffee roaster system and a roasting environment temperature;
means for calculating during the roasting process a polynomial curve corresponding to a desired polynomial profile, based on a change in temperature of said coffee beans during said roasting process and at pre-determined time intervals, beginning from the time of a designated initial measurement of the temperature of said coffee beans until the time the temperature of said coffee beans attains a pre-determined hold temperature;
means for transmitting monitored measurements from said means for monitoring the temperature of coffee beans loaded in the roasting environment of said coffee roaster system and the roasting environment, to said means for calculating during the roasting process the polynomial curve;
means for inputting and/or transmitting to said means for calculating during the roasting process the polynomial curve, coffee roasting profile data including time-temperature points at the predetermined time intervals, said hold temperature, and a desired final temperature; and
heat output control means for controlling the heat output of the heating source of said coffee roaster system by reference to said polynomial curve and said roasting profile data wherein the heat output is held to a constant maximum value until the temperature of the coffee beans attains the hold temperature value, and thereafter is adjusted so that the temperature of the coffee beans at specific time intervals approximates the temperature along the polynomial curve, until the temperature of the coffee beans reaches the desired final temperature, at which time the heat output is reduced to zero.

15. The system according to claim 14, further comprising means for automatically turning off the heating source when the desired final temperature is reached, and for providing indication to an operator that it is time to release the roasted coffee beans from the roasting environment.

16. The system according to claim 14, wherein the control temperature monitoring and operational data processing means further monitors one or a combination of ambient bean temperature, environment temperature, bean moisture, humidity, barometric pressure and air flow.

17. The system according to claim 14, wherein the polynomial curve is calculated based on predetermined time-temperature data point or points and actual time-temperature data point or points specific to a roast process to be implemented.

18. The system according to claim 14, wherein the polynomial curve is defined entirely by predetermined time-temperature data points.

19. The system according to claim 17, wherein the actual time-temperature data point or points take into account additional variables that affect the roast process, said variables including an initial coffee bean temperature, an coffee bean moisture content, an external environment temperature, an external humidity, a gas pressure to a burner, a coffee bean density, all of which affect an initial rise in temperature while the burner is being held at a constant output until the hold temperature value is reached.

20. The process according to claim 14, wherein a coffee bean temperature probe is positioned so as to consistently monitor said coffee bean temperature regardless of quantity of coffee beans being roasted.
